(19) United States
(12) Patent Application Publication
(10) Pub. No.: US 2007/0248500 A1
(43) Pub. Date: Oct. 25, 2007

(54) INTERNALLY COOLED COATED FIBER DEVICE

(75) Inventors: Janusz Pawliszyn, Waterloo (CA); Yong Chen, Mississauga (CA)

Correspondence Address: SENNIGER POWERS (SGM), ONE METROPOLITAN SQUARE, 16TH FLOOR, ST. LOUIS, MO, 63102, US

(73) Assignee: Janusz Pawliszyn, Waterloo (CA)

(21) Appl. No.: 11/737,594

(22) Filed: Apr. 19, 2007

Related U.S. Application Data
(60) Provisional application No. 60/793,078, filed on Apr. 20, 2006.

(51) Int. Cl. B01L 11/00

(52) U.S. Cl. 422/101

(57) ABSTRACT

An internally cooled solid phase microextraction device that provides for quantitative sampling of volatile and semi-volatile organic compounds in complex samples. The device temperature is controlled the device design enables repeated use without failure. The device is miniaturized allowing it to be used with autosamplers known in the art.

### FIELD OF THE INVENTION

The present invention generally relates to an internally cooled coated fiber device and process for solid phase microextraction. The present invention increases analyte concentration in a fiber sorbent from a source of analytes contained in a sample by increasing the temperature differential between the sample and the fiber sorbent.

### BACKGROUND OF THE INVENTION

As described in U.S. Pat. No. 6,537,827 (to Pawliszyn), it is known to extract analytes using a sorbent fiber (either uncoated or coated with a polymeric coating) to extract organic compounds from their matrix and to directly transfer the analytes to an analytical instrument through thermal desorption. For example, the analytes can be transferred into a gas chromatograph through thermal desorption in a GC injector. The fiber can extract the analytes by dipping all or part of the fiber directly into the sample containing analytes or by contacting the fiber with a headspace located above the liquid containing analytes. This process is referred to as solid phase microextraction (SPME). SPME has been used successfully for analyzing volatile organic compounds (those listed in U.S. Environmental Protection Agency Method 624, polyaromatic hydrocarbons (PAH's), polychlorinated biphenyls, phenol and its derivatives in aqueous samples. SPME can also be used to analyze volatile and semi-volatile organic compounds in more complex samples such as soil and sludge by having the analytes contact the fiber in a headspace above the sample matrix. Sometimes, the SPME approach suffers from disadvantages in that many matrices do not release sufficient analytes. Thus, the analytes transferred to the fiber are not sufficient to produce a detectable signal when the analytes are desorbed in an analytical instrument. Also, the SPME is typically not a quantitative extraction method and therefore, it requires careful calibration procedures.

U.S. Pat. No. 5,496,741 (to Pawliszyn), describes an internally cooled SPME sampling device useful for increasing analyte recovery and transfer of analytes to an analytical instrument through thermal desorption. Although useful, the sampling device design results in frequent septum replacement, frequent sorbent coating failure, sampler leakage, coolant supply tubing crimping and failure and the device was not readily adaptable for automation.

There exists a need for SPME sampling devices that allow for continuous use without failure, that can be automated, and that can provide quantitative sampling of volatile and semi-volatile organic compounds in complex samples.

### SUMMARY OF THE INVENTION

Among the various aspects of the present invention are improved internally cooled solid phase microextraction devices that provide for temperature control and repeated use without failure, and provide for quantitative sampling of volatile and semi-volatile organic compounds.

Briefly, therefore, the present invention is directed to a solid phase microextraction device comprising a sorbent, an internal cooling device and an internal thermocouple. The internal thermocouple measures sorbent temperature, the internal cooling device is operatively connected to the sorbent, and the internal cooling device comprises a tube for supplying a coolant.

The present invention is further directed to a solid phase microextraction method comprising heating a sample to generate a vaporized analyte and exposing the vaporized analyte to a solid phase microextraction device. The solid phase microextraction device comprises a sorbent, an internal thermocouple, and an internal cooling device comprising a tube for supplying a coolant. The internal cooling device is operatively connected to the sorbent and the sorbent is cooled to a temperature of from about −20° C. to about 25° C. The analyte is absorbed into the sorbent and then desorbed into an analytical instrument.

The present invention is further directed to a solid phase microextraction device comprising a sorbent, an internal cooling device and a needle. The needle comprises a tube having a passage therethrough, the cooling device comprises a thermoelectric fiber, the sorbent comprises a fiber coating on the thermoelectric fiber and the thermoelectric fiber is operatively connected to the sorbent, and the fiber coating on the thermoelectric fiber is received into the passage.

The present invention is further directed to a solid phase microextraction method comprising heating a sample to generate a vaporized analyte and exposing the vaporized analyte to a solid phase microextraction device. The solid phase microextraction device comprises a thermoelectric cooling wire having an operationally connected sorbent disposed thereon. The sorbent is cooled to a temperature of from about −20° C. to about 25° C. The analyte is absorbed into the sorbent and then desorbed into an analytical instrument.

Other objects and features of this invention will be in part apparent and in part pointed out hereinafter.

### BRIEF DESCRIPTION OF THE DRAWINGS

FIG. 1 is a sectional side view of an internally cooled fiber device of the present invention.

FIG. 2 is a sectional side view of a thermoelectric cooled fiber device of the present invention.

FIG. 3 is a representation of an automated internally cooled fiber device of the present invention.

FIG. 4 is a plot of the extraction recovery (n=3) of toluene, ethyl benzene and o-xylene in air samples using the automated internally cooled SPME device of the present invention.

FIG. 5 is a plot of the extraction recovery (n=3) of PAHs at 100° C. from air using the internally cooled SPME device of the present invention.

FIG. 6 is a plot of the extraction time profile of butyl acetate incubated at 45° C. using the internally cooled SPME device of the present invention.

FIG. 7 is a plot of the extraction time profile of heptyl acetate incubated at 45° C. using the internally cooled SPME device of the present invention.

FIG. 8 is a plot of the temperature effect on the extraction of heptyl acetate from the headspace of an aqueous solutions using the internally cooled fiber of the present invention cooled to about 1° C.

FIG. 9 is a comparison of the extraction of butyl acetate from the headspace of an aqueous solution with and without agitation. The internally cooled fiber of the present invention was cooled to 1° C. during the extraction. Samples were incubated at 30° C.

FIG. 10 is a comparison of the extraction of heptyl acetate from the headspace of an aqueous solution with and without agitation. The internally cooled fiber of the present invention was cooled to 1° C. during the extraction. Samples were incubated at 30° C.

FIG. 11 is a plot of the evaluation of the effect of sample volume on sample recovery percentage. Extraction of small amounts of samples was done using the internally cooled fiber of the present invention in 20 mL vials.

FIG. 12 is a plot of the evaluation of the effect of vial volume on sample recovery percentage. Extraction of 50 μL of 1% shampoo standard aqueous solutions was done using the internally cooled fiber of the present invention. The extraction time was 45 min.

FIG. 13 is a plot of the evaluation of the effect of sampling temperature on the extraction of perfume compounds from 50 μL 1% shampoo aqueous solutions using the internally cooled fiber of the present invention that was cooled to 1° C. during extraction.

FIG. 14 is a plot of the extraction-temperature profile of 100 ng/g PAHs in sand samples using the cold-fiber device of the present invention with an extraction time of 30 min (200 ng of each compound in 2 g sand sample, temperature of the cold-fiber: 5° C.).

FIG. 15 is a plot of the extraction-time profile of 100 ng/g PAHs in sand samples using the cold-fiber device of the present invention with an extraction temperature of 150° C. (200 ng of each compound in 2 g sand sample, temperature of the cold-fiber: 5° C.).

FIG. 16 is a plot of the effect of desorption time on the carry-over of Fluoranthene and Pyrene (200 ng of each compound in 2 g sand sample was extracted at 150° C. for 40 min, temperature of the cold-fiber: 5° C.

FIG. 17 is a plot of effect of extraction-time profile of 100 ng/g fluoranthene and pyrene in sand samples using the cold-fiber device of the present invention at an extraction temperature of 150° C. (200 ng of each compound was added to 2 g sand samples and the temperature of the cold-fiber was 5° C.).

FIG. 18 is a plot of the analysis of EC-6 reference certified sediments using cold fiber-SPME method (Erie Lake reference sediment).

FIG. 19 is a plot of the analysis of EC-2 reference certified sediments using the CF-HS-SPME method (Ontario Lake reference sediment).

FIG. 20 is a chromatogram of extracted PAHs from EC-6 certified reference sediment using the cold fiber-SPME device of the present invention (extraction temperature: 150° C., extraction time: 180 min, temperature of the cold-fiber: 5° C.).

Corresponding reference characters indicate corresponding parts throughout the drawings.

### DESCRIPTION OF THE PREFERRED EMBODIMENTS

The present invention is generally directed to an improved internally cooled solid phase microextraction device (SPME device) that provides for temperature control and repeated use without failure and provides for quantitative sampling of volatile and semi-volatile organic compounds in even complex samples. The device is miniaturized allowing it to be used with autosamplers known in the art.

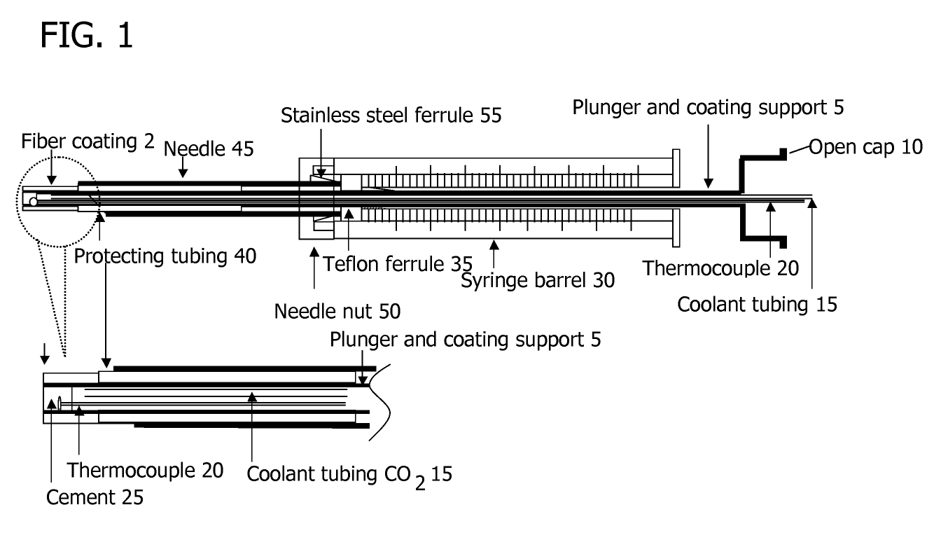

One aspect of the invention is illustrated in FIG. 1 and is directed to a SPME device supplied with a cooling source, such as carbon dioxide (CO₂). In FIG. 1, tubing is used as a SPME device plunger and fiber coating support 5. One end of the tubing 5 is connected to an open cap 10. The open cap 10 can be used to provide a physical connection with an autosampler (not shown) so that a sorbent (i.e., fiber coating) 2 can be exposed outside a needle 45 or automatically withdrawn inside the needle via an autosampler injection arm (not shown). Coolant tubing 15 is located in the plunger and fiber coating support 5. The large inner volume of the cap 10 provides sufficient space to bend the coolant delivering tubing 15 to 90 degrees when the cap is mounted in the autosampler injection arm (not shown). The other end of the tubing is sealed with high temperature cement 25. A thermocouple 20 is located in the plunger and fiber coating support 5 and is used to monitor the temperature of the fiber coating 2, with the probe of the thermocouple located at about 2 mm away from the opening (see magnified part of FIG. 1). The thermocouple 20 is fixed by cement 25 so that the movement of the device is fixed. Sufficient cement 25 is used to ensure there was no leak in the plunger and fiber coating support tubing 5. The plunger and fiber coating support tubing 5 is located in an empty barrel 30 of a gas-tight syringe (e.g., 100 μL). A TEFLON® ferrule 35 is attached to the barrel 30 to provide physical support of the plunger and fiber coating support 5 in the barrel 30. The TEFLON ferrule also prevents leakage when the needle 45 is inserted into an injection port (not shown). A piece of protecting tubing 40 is located on the plunger and fiber coating support 5 about 1 cm away from the opening. The outside diameter (O.D.) of the protecting tubing 40 is preferably slightly larger than that of the fiber coating 2 to protect the fiber coating 40 during withdrawal inside the needle 45, thereby avoiding stripping of the fiber coating 2 from the plunger and fiber coating support 5. The needle 45 is connected to the syringe barrel 30 via a needle nut 50, which tightens a stainless steel ferrule 55. The TEFLON ferrule 35, placed between the stainless steel ferrule 55 and the barrel 30 provides a leak-free injection.

The SPME devices of the present invention provide significant improvement over prior art devices. Firstly, the addition of the protecting tubing attached to the plunger prevents fiber coating failure such that extended continuous use of the SPME device can be done without coating failure. Secondly, the use of two ferrules (stainless steel and TEFLON), as compared to the prior art SPME devices having only a stainless steel ferrule, ensure tight physical connection between the needle, the plunger and coating support, and the barrel thereby providing leak-free injection. Thirdly, addition of the plunger cap prevents bending of the tubing observed in prior art SPME devices allowing easy manual and automated operation of the device.

In another aspect of the present invention, the SPME device described above is miniaturized. Miniaturization allows the SPME device of the present invention to be used with autosamplers known in the art. Moreover, miniaturization, in particular the syringe needle, allows it to serve as a protecting shield when the fiber coating is introduced into a sample vial for extraction or into an injection port for desorption. Further, the small diameter tubing used as the needle enables continuous use of the same septum for more than 15 times for manual injection and for more than 30 times for automated injection. In one embodiment tubing as small as 18 gauge and having an I.D. of about 1.14 mm and a O.D. of about 1.27 mm can be used for the needle. Prior art SPME devices, having larger diameters, typically require septum replacement after about 5 injections. Moreover, as compared to prior art SPME devices, miniaturization facilitates automated operation. The dimensions of the needle depend on the dimensions of the fiber coating and of the plunger and fiber coating support, and the size of the latter also depends on the tubing which delivers the coolant and of the thermal couple wires. In general, the thinnest commercially available thermocouple wire with an insulation layer is about 0.08 mm (0.003 inch). The dimensions of the tubing delivering coolant are partially dependent on the application. In general, the higher the desired temperature of the sample, the more coolant (e.g., CO₂) needed, thus the larger the tubing required. The use of 30-gauge thin wall (I.D. 0.15 mm; O.D. 0.30 mm) stainless steel tubing was shown to cool the fiber coating to about 0° C. even at the highest permitted temperature of a CombiPAL agitator (about 200° C.). The smallest tubing selected for the plunger and fiber coating support, and compatible with the dimensions of the tubing delivering CO₂ and of the thermal couple wires, was 22xx-gauge (I.D. of 0.60 mm, O.D. of 0.71 mm). In one embodiment, a 1 cm long PDMS (polydimethylsiloxane) tubing with inner diameter (I.D.) 0.30 mm and wall thickness 0.18 mm was used, providing about 2.4 μL of extraction phase. The PDMS tubing was enlarged by soaking in hexane prior to being attached to the support/plunger. Vaporization of hexane ensured a tight attachment of the PDMS tubing onto the support. The smallest external tubing which was found to accommodate the PDMS coating and its support was 18-gauge (I.D. of 1.14 mm, O.D. of 1.27 mm) stainless steel tubing.

Another aspect of the invention is directed to a SPME device based on a thermoelectric (e.g., Peltier) cooling system (TEC). In this embodiment, a cold fiber can be used to collect particles without size discrimination via thermophoretic processes. Cooling of the fiber can be preferentially accomplished by using metal fiber connected to the solid state cooler (Peltier electronic heat pump). The fiber can be coated with appropriate extraction phase to facilitate extraction of dissolved compounds or particulate matter present in the matrix. In a Peltier system the fibers are typically made of a good conductivity metal, such as copper, gold or an appropriate alloy (i.e., a thermoelectric fiber). The temperature can be controlled by a micro-thermocouple mounted in the tip of the fiber and a temperature control, optionally including feedback, similar to that described for CO₂ cooling.

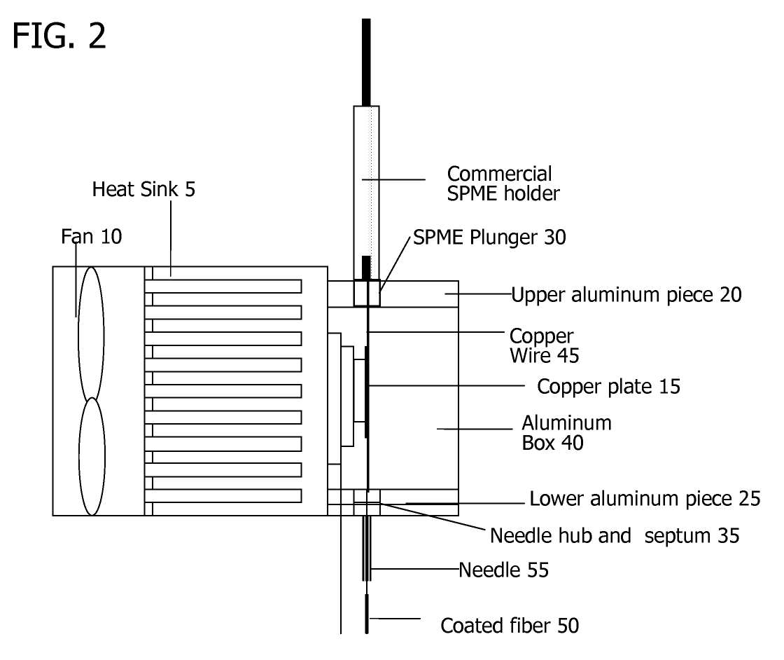

FIG. 2 illustrates a TEC system of the present invention wherein a TEC cools a copper wire (i.e., a thermoelectric fiber) contained in a needle that is used for the collection of particulate matter. The hot side of the thermoelectric cooler (TEC) is attached to a heat sink 5, which is in turn attached to a fan 10. A copper plate 15 is attached to the cold surface of the TEC. A groove of about 0.5 mm depth is made in the middle of the copper plate 15 to act as a seat for the SPME fiber. A thermocouple (not shown) is embedded at the copper plate 15 close to the groove to monitor the temperature of the cold side of the TEC. Two pieces of aluminum (upper 20 and lower 25 pieces) are machined to serve as the seat for the SPME plunger 30 (upper piece), the septum and the needle hub 35. Three aluminum plates are also used as the sides of the device 40. A small machined plastic part is mounted on the SPME plunger to hold a copper wire 45. In order to achieve better cooling, the empty space between the copper plate and the aluminum parts is filled with glass wool (not shown). A SPME fiber was made using a copper wire 45 of 0.762 mm diameter and 8.5 cm length. One centimeter of a polydimethyl siloxane (PDMS) hollow fiber 50 was cut, swollen in hexane, and placed at the tip of the copper wire to serve as the extraction phase. Stainless steel tubing of sufficient diameter to receive the coated fiber 50 is used for the needle 55. A direct current (DC) power supply (not shown) and a voltage regulator (not shown) are used to supply the appropriate power both to the TEC and the fan 10. In one embodiment, the power source is a battery allowing for portability of the TEC device. The temperature of the cold side of the TEC is controlled by the direct current passing through TEC. The PDMS coating 50 is cooled through heat transfer along the copper wire 45, which is in contact with the cold surface of the TEC.

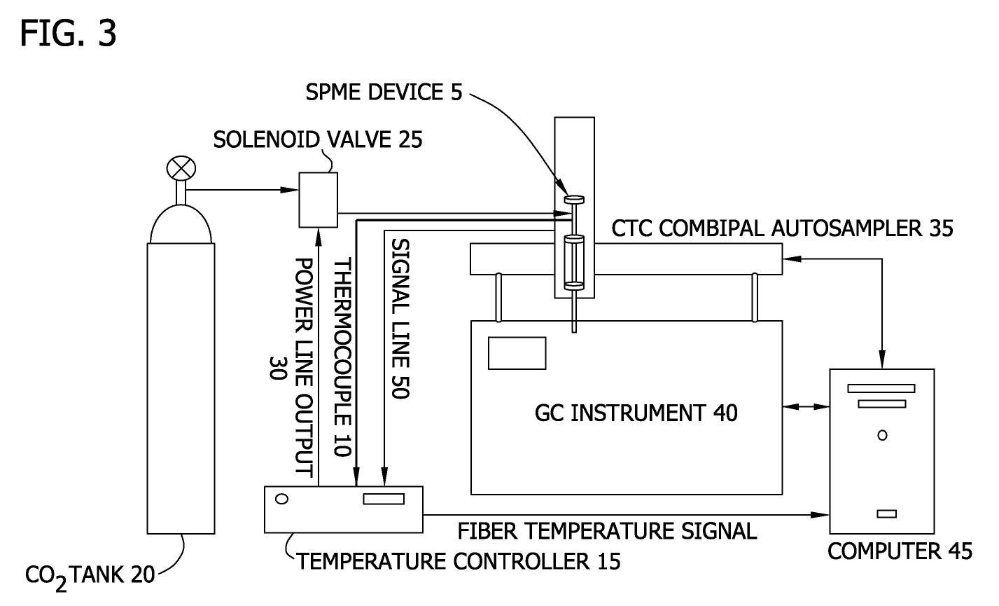

Another aspect of the present invention is illustrated in FIG. 3 and is directed to an automated SPME device of the present invention using an autosampler, such as, for example, a Combi PAL autosampler. FIG. 3 depicts an aspect of the present invention wherein the sorbent temperature is maintained around a setpoint with an automated control loop. In the case of liquid cooling, the control loop comprises a SPME device 5 having an internal thermocouple (not shown) that measures and transmits a sorbent temperature 10 to a temperature controller 15, a source of coolant 20, an internal coolant tube (not shown) located in the SPME device 5 for receiving the coolant 20, a modulating control valve (e.g., a solenoid valve) 25 for regulating coolant flow to the SPME device. The temperature controller 15 receives the sorbent temperature input signal from the thermocouple 10 and sends an output 30 to the control valve 25 thereby regulating coolant 20 flow maintaining the sorbent temperature around the setpoint. The SPME device 5 was mounted in an autosampler 35 for automatic introduction of the sample into a GC instrument 40. In one embodiment, the autosampler 35, temperature controller 15 and GC instrument 40 are coupled to enable the controller to be activated and deactivated by a signal 50 from the autosampler control software. In another embodiment, the temperature controller 15 and autosampler 35 can be coupled with a computer 45 to enable other control schemes.

Automated operation allows for precise SPME device temperature control that is useful to maintain desired temperature differentials between the cooled fiber sorbent and the heated sample. The present invention allows for the selection and maintenance of a preset cooled fiber temperature such that stable temperature differentials may be selected for and attained. SPME device cooled fiber temperatures can be maintained at ±5° C., ±4° C., ±3° C. or even ±2° C. around a setpoint of from about −20° C. to about 25° C., even when sample temperatures are as high as about 300° C. Stable and preset temperature differentials increase sample extraction efficiency and enable quantitative extraction even for semi-volatile organic compounds (SVOCs).

Another aspect of the present invention is directed to the collection of particles of nanometer size for the purpose of both characterizing and determining the concentration. This aspect involves the thermophoretic collection of nanoparticles on a cold fiber in the SPME device, followed by a convenient interface to analytical instruments and characterization of the matrix of the particle as well as the chemical species adsorbed on its surface.

Another aspect of the present invention is directed to a process for increasing analyte concentration in a sorbent from a source of analytes contained in a sample by increasing the temperature differential between the sample and the sorbent using a SPME device of the present invention. In one embodiment, the temperature differential is increased by reducing the sorbent temperature to as low as about −20° C.

SPME is a simple and convenient sample preparation technique that can be automated. SPME involves exposing a fused silica fiber that has been coated with a non-volatile sorbent to a sample headspace. The sample analytes are absorbed into the fiber. The absorbed analytes are thermally desorbed in the injector of an analytical instrument such as a gas chromatograph (GC) or GC-mass spectrometer. The fiber is contained in a syringe-like SPME device to facilitate convenient handling. This method can be applied to liquid, gaseous or headspace samples. All three sample types can be analyzed on the same instrument without modifications to the GC. The extraction and the sample injection process can be fully automated using a conventional autosampler. In the headspace mode, SPME operates in analogues fashion as the static headspace technique with the additional advantage that semivolatile compounds can be analyzed simultaneously with volatiles. Similarly as static headspace, headspace SPME is effected by competitive effects in the matrix which reduces its sensitivity and accuracy when applied to quantification of analytes in complex matrices. Applications of higher temperatures facilitate the release of analytes from the matrix.

In headspace SPME, there are two processes involved: the release of analytes from their matrix and the absorption of analytes by the fiber coating. For quantitative extraction to be successful, the majority of the analyte molecules should be released into the headspace. If a significant proportion of the analyte molecules are strongly retained by the matrix during the extraction, quantitative extraction is difficult to achieve. Extraction conditions should be selected that are able to facilitate the release of most of the analyte molecules. Thermal desorption at high temperatures (for example, greater than about 100° C.) can usually release most volatile organic compounds from simple matrices. Sample heating for thermal desorption can be done by methods known in the art, for example, convective heating, microwave heating, sonication or a combination thereof. With the help of some chemical modifiers, such as organic solvents, thermal desorption may do the same for VOCs in more complex matrices. Then, with most analyte molecules released into the headspace during the extraction, quantitative extraction can be achieved if the fiber coating exhibits very large partition coefficients for the target analytes.

Under one theory, and without being bound to any particular theory, during SPME, the amount of analytes absorbed by the fiber coating can be expressed as:

n=(KₒV_{f}CₒVₛ)/(KₒV_{f}+Vₛ) (Eq. 1)

where n is the mass absorbed by the fiber coating; V_{f} and Vₛ, are the volumes of the fiber coating and the headspace, respectively; Kₒ is the partition coefficient of an analyte between the fiber coating and the headspace; and CO is the initial concentration of the analyte in the headspace. Because of the small dimension of the fiber, the volume of the fiber coating (V_{f}) is quite small, typically about 10-3 ml. In most cases, analytes are not completely extracted. In other words, SPME is mainly an equilibrium extraction method. The concentration of an analyte is determined by its linear relationship with the amount of the analyte extracted by the fiber coating instead of by the total extraction of the analyte. However, if the partition coefficient (Kₒ) is very large, the term of KₒV_{f} can be much larger than Vₛ (KₒV_{f}>>V). It is then achieved:

n=CₒVₛ (Eq. 2)

which means that the “analyte is totally extracted by the fiber coating”. However, most volatile organic compounds have values of Kₒ that are not large enough to meet the condition of KₒV_{f}>>Vₛ under normal circumstances. In order to achieve exhaustive extraction, a smaller sample volume, Vₛ, could be used, but that means using a smaller sample size, which is not desirable for the accurate analysis of a sample. Increasing the volume of the fiber coating is another option, but it is unpractical since one of the most important advantages of SPME is the small dimension of the coated fiber and, consequently, no need for modification of the GC injector. One possible approach is to use a coating that has a very strong affinity toward the target analytes, thus exhibiting very large Kₒ values.

A much easier and more readily applicable method is to increase the coating/headspace partition coefficients by creating a temperature gap between the fiber coating and the sample headspace. The advantage of this approach is that, not only are the partition coefficients increased, but the release of the target analytes from their matrix to the headspace via thermal desorption is also facilitated. Since the absorption of analytes is an exothermic process, maintaining the fiber at low temperature has additional advantages. The temperature gap in the headspace SPME sampling can be achieved by heating the sample vial with its headspace to an elevated temperature, while cooling the fiber coating to prevent the coating from heating. The thermal desorption and increased coating/headspace partition coefficients of the analytes are achieved simultaneously, which provides an excellent environment for quantitative extraction of VOCs.

It has been demonstrated that use of elevated temperatures facilitates release of analytes from complex matrices. See J. Langenfeld, S. Hawthorne, D. Miller, J. Pawliszyn “Effects of Temperature and Pressure on Supercritical Fluid Extraction Efficiencies of Polycyclic Aromatic Hydrocarbons and Polychlorinated Biphenyls” Anal. Chem. 65, 338-344 (1993). In addition, there is strong evidence that water molecules are very good displacing agents. Typically, a few percent of water content in the sample is sufficient to release organic compounds from soils. It was found that if thermal gradient is applied in the system by heating the sample containing about 5% moisture with simultaneous cooling of the extraction phase (fiber coating), rapid and close to quantitative extraction is possible even for volatile analytes. See Z. Zhang, J. Pawliszyn Quantitative Extraction Using an Internally Cooled Solid Phase Microextraction Device Anal. Chem. 67, 34-43 (1995). See also J. Pawliszyn, “SPME, Theory and Practice”, Wiley, N.Y. 1997, pp. 24-27.

It has been discovered that high temperature and moisture helps to release analytes from the matrix and therefore improves kinetics and efficiency of the extraction process. Analyte mass transfer has been discovered to be much faster in the system because of the higher diffusion coefficients at elevated temperatures, as well as due to increased convection and thermophoresis effects caused by temperature gradients in the system. The Henry constant, and therefore concentration of analytes in headspace, is higher at elevated temperatures resulting in faster transport of analytes to the extraction phase. The cold sorbent allows a large temperature gap between the sample matrix and the extraction phase (i.e., sorbent) resulting in an enhanced distribution constant, and therefore higher sensitivities facilitating high recovery and therefore good quantification even for complex and variable matrices. As compared to the purge and trap technique known in the art, the improved SPME technology of the present invention provides the additional capability to extract semivolatile species. Moreover, analyte carryover associated with the complex purge and trap system should be eliminated since the fiber is cleaned in the injector during sample introduction prior to every extraction.

SPME devices of the present invention, when cooled with liquid CO₂, can be cooled by the expansion of liquid CO₂ to maintain the fiber coating at temperatures of −20° C., −15° C., −10° C., −5° C., −0° C., 5° C., 10° C., 15° C., 20° C. or even 25° C. when samples are heated to temperatures of 50° C., 60° C., 70° C., 80° C., 90° C., 100° C., 110° C., 120° C., 130° C., 140° C., 150° C., 160° C., 170° C., 180° C., 190° C., 200° C., 210° C., 220° C., 230° C., 240° C., 250° C., 260° C., 270° C., 280° C., 290° C., 300° C., 310° C., 320° C., 330° C., 340° C. or even 350° C. In one embodiment, a temperature of about 0° C. can be maintained when a sample is heated to temperatures as high as 300° C. Creating a temperature gap between the cold fiber coating and the hot headspace of the samples not only facilitates the mass transfer and the release of analytes into the headspace, but also significantly increases the distribution coefficients of the analytes. With this method, quantitative extraction has been achieved for VOCs, such as BTEX (benzene, toluene, ethyl benzene, and xylene) from gas, water, or soil in 5 minutes. In an advance over the art, quantitative extraction of SVOCs is also possible. Experimental evidence to date indicates that quantitative extraction from air for the SVOCs naphthalene, acenaphthylene, acenaphthene and fluorene can be achieved with the SPME devices of the present invention. Further, improved extraction of aroma ingredients such as organic compounds having a wide range of volatility and polarity, represented by butyl acetate and heptyl acetate, can be achieved with the SPME device of the present invention. Increases in extraction efficiency of organic compounds over the art by a factor of 2 to 11 was observed.

Thermophoretic deposition of nanoparticulate matter on SPME devices has been demonstrated to be effective in the collection of nanoparticles in air. See J. J. Bang, L. E. Murr, E. V. Esquivel, Materials Characterization 52, 1-14 (2004). In contrast, typical prior art collection devices such as impactors, electrostatic precipitators and filters are ineffective in nanoparticulate matter collection and work only down to about the 1 micrometer size, and their collection efficiency drops rapidly with a decrease in size, resulting in substantial size discrimination. See R. C. Flagan, J. Seinfeld, “Fundamentals of Air Pollution Engineering”, Prentice Hall, Englewood Cliffs, N.J., 1988. See also A. G. Clarke, G. A. Azadi-Boogar, G. E. Andrews, The Science of the Total Environment 235, 15-24 (1999). It has been demonstrated that nanoparticulate matter can be characterized using a fiber format after impact collection. See J. Koziel, M. Odziemkowski, J. Pawliszyn, Anal. Chem. 73, 47-54 (2001). See also J. Koziel, M. Odziemkowski, D. Irish, J. Pawliszyn, Anal. Chem. 73, 3131-3139 (2001). Modified SPME devices containing metal fibers and cooling means of the present device may be used for efficient nanoparticle collection. Theory indicates that thermophoresis is the dominant mass transfer mechanism of suspended particles onto the cold surface of the fiber. Thermophoretic deposition is nearly independent of particle size thus providing an unbiased sample of airborne particulates. See G. Kasper, Rev. Sci. Instrum. 53, 79-82 (1982); See also, J. J. Bang, L. E. Murr, E. V. Esquivel, Materials Characterization 52, 1-14 (2004). The collected particles and/or chemical species from the modified SPME device adsorbed on the particle surface can be conveniently characterized by chromatographic and spectroscopic means by desorbing the fibers into analytical instruments. Such measurements will allow for the characterization of the reactivity of the particles. Another important application of the present device is in the study of the permeation rate of the particles through the porous barrier. Such measurements would facilitate of better understanding of access through diffusion and translocation across barriers. Also, this approach based on thermophoretic collection and characterization of nanoparticles is compatible with liquid samples as well.

Thermophoresis is a physical phenomenon occurring in the drift of the dispersed particles along the thermal gradient towards the cooler surface. See J. Aiken, “Collected Sci. Papers”, C. S. Knot, ed., Cambridge U. P., Cambridge, 1923, p. 84. See also G. Kasper, Rev. Sci. Instrum. 53, 79-82 (1982). Under one theory of particle deposition on a cooled fiber, and without being bound to any particular theory, in a one-dimensional model depicted below

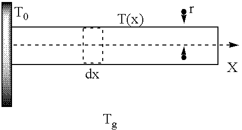

where T=T(x), T₀ is the temperature of the cold surface, T_{g} is the temperature of the gas sample, and r is the radius of the metal fiber, the energy balance πr²dq(x)=α2πrdx[T(x)-T_{g}] leads to

$$\frac{{d}^{2} T}{d {x}^{2}} = \frac{2 α}{{λ}_{f} r} [ T ( x ) - {T}_{g} ]$$

where λ_{f} is the heat conductivity of the fiber material, α is the heat transfer coefficient between fiber and surrounding gas.

During SPME, the amount of analytes absorb Introduction of dimensionless length and temperature:

$$ζ = \frac{x}{L}$$

$$θ = \frac{T - {T}_{g}}{{T}_{0} - {T}_{g}}$$

yields:

$$\frac{{d}^{2} θ}{d {ζ}^{2}} = {γ}^{2} θ$$

$${γ}^{2} = \frac{2 α {L}^{2}}{{λ}_{f} r}$$

and the solution

$$θ = \frac{cosh [ γ ( 1 - ζ ) ]}{cosh γ}$$

### The heat transfer is related to the Nusselt number Nu and the heat conductivity of the surrounding gas λ_{g}.

$$Nu = \frac{α {d}_{f}}{{λ}_{g}}$$

$$α = \frac{Nu {λ}_{g}}{{d}_{f}}$$

For the Nusselt number, the following correlations are used:

$$Nu = 0.3 + [ {Nu}_{l}^{2} + {Nu}_{t}^{2} ]$$

$${Nu}_{l} = 0.64 {Re}^{1 / 2} {Pr}^{1 / 3}$$

$${Nu}_{t} = \frac{0.037 {Re}^{0.8} Pr}{1 + 2.44 {Re}^{- 0.1} ( {Pr}^{2 / 3} - 1 )}$$

These examples illustrate the increase of the fiber surface temperature for:
λ_{g}=0.025 W/(mK) λ_{f}=400 W/(mK)
d_{f}=300 L=1 cm

For small Reynolds numbers, there is no significant increase in the surface temperature of the fiber. For thicker fibers, the efficiency of the cooling fiber increases. On the other hand, thin fibers, such as 0.3 mm O.D. fibers, fit very conveniently inside a needle for protection and convenient introduction to an analytical instrumentation, such as a gas chromatograph, for the characterization of collected particles. The fiber temperatures along its length will be determined experimentally by using micro thermocouple devices. For a low Reynolds flow around a cooled cylinder two major mass transfer mechanisms are assumed: diffusion and thermophoresis. The mass flux is determined by two boundary layers:

### The thermal boundary layer

$${δ}_{t} = \frac{{d}_{f}}{Nu} = 0.4 {d}_{f} \\ ( for = Re = 10 )$$

and the concentration boundary layer:

$${δ}_{c} = {( APe )}^{- 1 / 3}$$

$$A \approx \frac{1}{4}$$

$$Pe = Re Sc$$

$$Sc = \frac{v}{D}$$

D is the particle diffusion constant (D=5 10⁻⁴ cm²/S for a 10 nm particle), and ν is the gas viscosity=0.2 cm²/s.

### For Re=10, δ=0.1 d_{f} results.

### The mass flux onto the fiber surface is given by j=ν_{dep}c, where c is the aerosol concentration outside the boundary layer and ν_{dep} is the so called deposition velocity.

$${v}_{dep}^{diff} = \frac{D}{{δ}_{c}}$$

For diffusional deposition:
For thermophoretic deposition:

$${v}_{dep}^{therm} = α \frac{Δ T}{{δ}_{t}}$$

where β=2.8 10⁻⁴ (δₜ in cm, ΔT in K). From this the ratio of the thermophoretic and diffusional mass flux is derived:

$$Γ = \frac{{v}_{dep}^{th}}{{v}_{dep}^{diff}} = \frac{β Δ T}{D} \frac{{δ}_{c}}{{δ}_{t}}$$

### This number takes a value of 3 for 10 nm particles and increases for larger particles since the particle diffusion constant decreases.

The discussion above indicates that the thermophoretic deposition is the controlling mass transfer mechanism even for a relatively small temperature difference between the fiber surface and the surrounding gas. For a 1 cm fiber, a fiber diameter of 300 μm and a mass concentration of particles in the air of 1 mg/m³ the mass transfer rate is:

$$R = 5 \cdot {10}^{- 2} \frac{ng}{s}$$

The above discussion indicates that the collection rate of the particles is proportional to its concentration and can be calculated from the amount of the particle collected at defined convection conditions. The convection conditions can be either controlled by fixing the gas flow or by measuring it with flow meter.

Having described the invention in detail, it will be apparent that modifications and variations are possible without departing from the scope of the invention defined in the appended claims.

### EXAMPLES

The following non-limiting examples are provided to further illustrate the present invention.

### Examples 1-6

Toluene, ethyl benzene and o-xylene were purchased from Sigma-Aldrich (Mississauga, ON, Canada). HPLC grade methanol was purchased from BDH (Toronto, ON, Canada), and naphthalene, acenaphthene, and fluorene were purchased from Supelco (Oakville, ON, Canada).

Benzyl acetate, geraniol (3,7-dimethyl-2,6-octadien-1-ol), Cetalox® ((+−)-8,12-epoxy-13,14,15,16-tetranorlabdane), aroma model components (Hexanal, butyl acetate, (E)-2-hexenal, isoamyl acetate, isobutyl isobutyrate, hexyl acetate and heptyl acetate), and ethanol were from Firmenich (Geneva, Switzerland). Galaxolide® (1,3,4,6,7,8-hexahydro-4,6,6,7,8,8-hexamethyl-cyclopenta[G]isochromene) was purchased from IFF (New York, N.Y., USA). Unperfumed shampoo bases and perfumed shampoo samples were from Firmenich, including sodium lauryl sulfate based conditioning shampoo, ammonium lauryl sulfate based conditioning shampoo, sodium lauryl sulfate based simple shampoo and a sodium lauryl sulfate based benchmark conditioning shampoo marketed product. Water was collected from a Millipore purifying system (Billerica, Mass., UAS).

Stainless steel tubing with different I.D. and O.D. were purchased from Vita needle (Needham, Mass., USA). Temperature controller (CN 8590 series), thermocouple wires, and high temperature cement were purchased from Omega (Stamford, Conn., USA). 100 μL Hamilton 1710 series gas-tight syringe, green septum, and ferrules were purchased from Supelco (Bellefonte, Pa., USA). A solenoid valve was purchased from Asco Valve Canada (Brandford, ON, Canada). Ten and twenty milliliter sample vials were used for automated analysis with magnetic crimp caps and PTFE coated silicone septa (Chromacol, Welwyn Garden City, UK).

Gas chromatography was performed on a Varian 3800 GC (gas chromatograph) coupled with FID (Flame Ionization Detection) using a Star Chromatography Workstation (ver 5.51). Automated analysis was performed using a CTC CombiPAL autosampler (Zwingen, Switzerland) using the associated Cycle Composer software (ver 1.4.0). The PAL was equipped with a SPME fiber/syringe holder and a temperature controlled six-vial agitator tray. Separation was performed using a 30 m×0.25 mm I.D., 0.25 μm DB-1 fused silica column (Supelco) installed in the Varian GC. Helium was used as carrier gas at a flow rate of 1 mL/min. The Varian FID was used at a temperature of 250° C. with gas flows for hydrogen, high purity air and make-up gas (nitrogen) set at 30, 300 and 25 ml/min, respectively.

For the analysis of toluene, ethyl benzene and o-xylene, the column temperature was maintained at 35° C. for 1 min and then programmed at 30° C./min to 230° C. The injector temperature was set to 250° C. For analysis of PAHs, the column was initially set at 45° C. for 2 minutes and then ramped at 20° C./min to 280° C., and held for 5 minutes. The injector temperature was set to 300° C. For the analysis of the aroma ingredients, the column was initially set at 45° C. for 1 min and then ramped at 10° C./min to 250° C. The injector temperature was set to 250° C. For analysis of perfume compounds the column was initially set at 45° C. for 1 min and then ramped at 5° C./min to 270° C. The injector was set at a temperature of 270° C.

### Example 1

An internally cooled SPME device was fabricated. In reference to FIG. 1, a piece of 163-mm 22xx-gauge stainless steel tubing was used as plunger and fiber coating support 5. One end of the tubing 5 was connected to an open cap 10 by silver meld. The open cap 10 was used to provide a physical connection with an autosampler (not shown) so that the fiber coating 2 could be exposed outside the needle 45 or automatically withdrawn inside the needle 45 via an autosampler injection arm (not shown). The cap 10 had a large inner volume that provided sufficient space to bend the CO₂ delivering tubing 15 to 90 degrees when the cap 10 was mounted in the autosampler injection arm (not shown). The other end of the tubing 5 was sealed with high temperature cement 25. The thermocouple 20 used to monitor the temperature of the fiber coating 2 was pulled through the plunger 5 from the open cap 10 to the fiber coating 2 prior to the seal. The probe of the thermocouple 20 was located inside the plunger tubing 5, at about 2 mm away from the opening and was fixed by cement 25 so that the movement of the device was completely fixed. Sufficient cement 25 was used to ensure there was no leak in the plunger tubing 5. Though the thermocouple 20 was actually measuring the temperature of the cement 25, due to the geometry of the device it was assumed that the measured temperature was a good approximation of the temperature of the coating 2. The plunger 5 was then inserted through an empty barrel of a 100 μL gas-tight syringe 30 from the up-end to needle-end. A piece of TEFLON ferrule 35 was machined and attached to the barrel 30 to provide physical support of the plunger 5 in the barrel 30. The TEFLON ferrule 35 also prevents leakage when the needle 45 is inserted into an injection port (not shown). A piece of 19-gauge (I.D. 0.81 mm, O.D. 1.07 mm) stainless steel tubing was squeezed onto the plunger 5 about 1 cm away from the opening and served as a protective tubing 40. Because the O.D. of the protecting tubing 40 was just slightly larger than that of the coated fiber 2, it protected the fiber coating 2 during its withdrawal inside the needle 45, and avoided the frequently observed stripping of the coating 2. Initial tests demonstrated that the coating 2 could be reproducibly re-used for more than 100 injections, whereas no fiber failure was observed. The needle 45 was 4.7 cm long with a beveled end, which helped to pierce through the septum (not shown). The needle 45 was connected to the syringe barrel 30 via a needle nut 50, which tightened a stainless steel ferrule 55. The TEFLON ferrule 35, placed between the stainless steel ferrule 55 and the barrel 30, ensured leak-free injection.

### Example 2

The SPME device of the present invention was automated. In reference to FIG. 3, a Combi PAL holder, designed for a 100 μL autosampler syringe, was used after having enlarged its concavity. The hole of the autosampler needle guide was also enlarged to accommodate a 17-gauge needle (O.D. of about 1.5 mm, I.D. of about 1.14 mm). The “auto detection” option in the control panel of the autosampler was turned off, and “fiber” was manually selected when the device was attached to the autosampler injection arm. The autosampler could then operate as if the device was a regular fiber. To introduce the needle of the device into the injector, the holes of GC septum nut and septum support were enlarged to accommodate a 17-gauge needle, and a 2 mm GC liner was used. The septum was pre-drilled to avoid coring and to prolong its lifetime. The agitator tray can rotate to agitate the sample, inducing also a circular movement and a bending of the SPME fiber during the extraction phase. The stiffness of the new internally cooled fiber was not compatible with such constraints, and the agitation in standard SPME programs had to be turned off. At high temperatures, the diffusion was fast and the temperature gap between the fiber and the sample facilitated convection inside the vial. Agitation was required only in case when the device worked in low temperatures, and it was then implemented by putting a micro magnetic stirrer beneath the agitator tray of the autosampler.

To ensure a reproducible extraction, a dedicated control loop monitored the CO₂ flow in the tubing to maintain the temperature of the fiber at its preset value. The thermocouple used to monitor the temperature of the fiber coating was connected to the temperature controller that could turn a solenoid valve on or off as required. The temperature of the fiber coating was controlled within 5 degrees of the preset value. Full automation of the process was realized by coupling the external temperature control system with the autosampler through a logic circuit built into the temperature controller. The controller could be turned on or off as required via the autosampler control software.

The miniaturized SPME device essentially operated like a syringe. Compared with the prior art devices, significant improvement was achieved as follows. Firstly, the use of 18-gauge tubing as the needle allowed continuous use of the same septum for more than 15 times for manual injection and for more than 30 times for automated injection. Prior art SPME devices required septum replacement after about 5 injections. The addition of the protecting tubing attached to the plunger prevented fiber coating failure and no such failures were observed throughout the experiments. Two ferrules (stainless steel 55 and TEFLON 35), were used to ensure tight physical connection between the needle 45, the plunger and coating support 5, and the barrel 30, and leak-free injection (FIG. 1). Fourthly, addition of the plunger cap 10 avoided the bending of the tubing 15 delivering CO₂, allowed easy manual operation of the device, and was adaptable for automation.

### Example 3

Hydrocarbons were extracted from air. Exhaustive extraction of volatile organic compounds (VOCs), such as BTEX (benzene, toluene, ethyl benzene, and xylene), from an air sample is rarely possible with SPME due to the small distribution coefficients of VOCs between air and the PDMS coating and the small volume of the coating, unless the sample volume is extremely small. Theoretical calculation (Eq. 3) estimates that the largest volume of the air sample to achieve an exhaustive extraction of toluene at room temperature with a PDMS fiber is 0.12 mL. The most often used vials for automation are 10 or 20 mL autosampler vials. It thus requires significant increase of the distribution coefficient to achieve exhaustive extraction with these sample volumes. Increase of the temperature of the sample and simultaneous cooling of the fiber coating were proved to be an efficient way to increase the distribution coefficient, and result in exhaustive extraction. With the SPME device of the present invention, it was demonstrated that fully automated quantitative extraction of toluene, ethyl benzene and o-xylene from air samples was feasible.

Instead of spiking a certain amount of liquid standards into air samples, a new approach to deliver a well-defined amount of standards was used. This approach utilized the exposure of a standards-loaded fiber (loaded previously from a standards generator) to the air samples contained in a sealed vial. See Chen, Y.; Wang, Y.; O'Reilly, J.; Pawliszyn, J. Analyst. 2004, 129, 702-703. See also Wang, Y.; O'Reilly, J.; Chen, Y.; Pawliszyn, J. J. Chromatogr. A. 2005, 1072(1), 13-17. Standards desorbed from the fiber, and back equilibration would be reached after a certain amount of time. The initial amount of the standards and the amounts of standards remaining in the fiber follow the same distribution law as the extraction process:

$${n}_{f} = \frac{{K}_{fs} {V}_{f}}{{V}_{s} + {K}_{fs} {V}_{f}} {n}_{0} \qquad Eq . 3$$

and,

nₛ=nₒ−n_{f} Eq. 4

where n_{f} is the amount of analyte in the fiber; nₛ is the amount of analyte in the matrix; n₀ is the total amount of analyte in the sampling system; K_{fs} is the fiber-to-coating distribution; Kₕₛ is the headspace-to-matrix distribution coefficient; V_{f} is the volume of fiber coating; Vₛ is the volume of sample matrix; and Vₕ is the volume of headspace. n₀ was determined by direct desorption of the fiber in the injector after loading the standards from the standards generator. Since the loading of a standard was very reproducible, and the determination of n_{f} and n₀ was fully automated, the recovery could be very accurately estimated without calibration, assuming that the detector responded linearly with mass. Utilizing FID as the detection, this was true throughout the experiments.

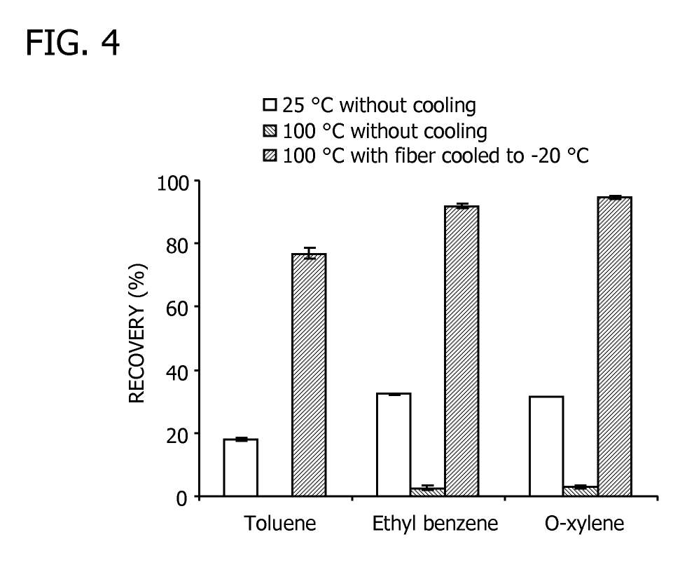

FIG. 4 presents the results of extraction of toluene, ethyl benzene and o-xylene in air samples using the automated internally cooled SPME device of the present invention. After reaching back equilibration of the standards-loaded fiber exposed to the vial headspace, it was found that only 18%, 32%, and 32% of respectively toluene, ethyl benzene, and o-xylene remained in the fiber at 25° C. if the fiber was not cooled. Heating up the sample to 100° C. without cooling the fiber significantly decreased the recovery of all analytes, whereas only 3% of ethyl benzene and o-xylene were left on the fiber. Under the same conditions, but with the fiber cooled to −20° C., ethyl benzene and o-xylene were almost completely retained on the fiber, and 80% of toluene was recovered. The simultaneous heating of the samples and cooling of the fiber significantly increased the distribution coefficient, thus more analytes could be recovered.

By exposing the analytes-loaded fiber to the vial headspace until back equilibration was reached, the distribution coefficient could be determined according to equation 5

$${K}_{fs} = \frac{{n}_{f}}{{n}_{0} - {n}_{f}} \cdot \frac{{V}_{s}}{{V}_{f}} \qquad Eq . 5$$

assuming the linear response of the detection (FID), n_{f} and n₀ could be replaced with corresponding peak area counts, thus calibration was not required to estimate the distribution coefficient. Table 1 summarizes the distribution coefficients determined by this approach. Corresponding distribution coefficients reported in the literature^{a} are reported for comparison.

TABLE 1
Air/PDMS distribution coefficients of toluene, ethyl
benzene, and o-xylene determined by coupling back
equilibration with the automated internally cooled fiber
device.

| Sample | Coating | | | |
|---|---|---|---|---|
| Temperature | Temperature | | | |
| (° C.) | (° C.) | Toluene | Ethyl benzene | O-xylene |
| 25 | 25 | 1050 ± 18 | 2300 ± 47(2020)^{a} | 2200 ± 47(2710)^{a} |
| | | (815)^{a} | | |
| 100 | 100 | N/A | 130 ± 4 | 140 ± 4 |
| 100 | −20 | 15900 ± 343 | 54400 ± 454 | 82000 ± 370 |

^{a}See Pawliszyn, J. Solid Phase Microextraction - Theory and Practice; Wiley - VCH; New York, 1997.

### Example 4

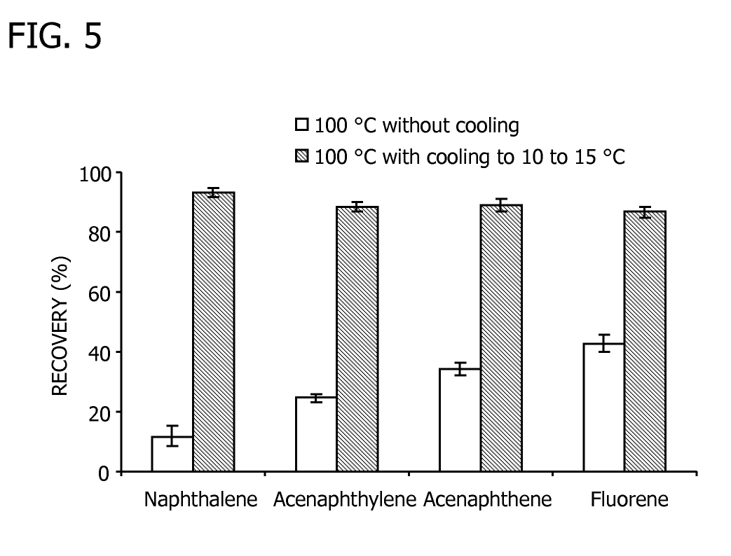

PAHs are a class of environmental pollutants that are generally classified as semi-volatile organic compounds (SVOCs). They strongly bind to matrixes, such as oil, soil, and particulates. Release of PAHs from these matrixes requires prolonged solvent extraction process or heating at higher temperatures. Extraction of PAHs at elevated temperatures suffers from the decrease of distribution coefficient. FIG. 5 demonstrates that there were ca. 10, 25, 35, and 45% of naphthalene, acenaphthylene, acenaphthene, and fluorene respectively left in the fiber when the temperature of the back equilibration was at 100° C. With the fiber cooled to 10° C. while the sample temperature was maintained at 100° C., all the PAHs were almost quantitatively recovered from the air. This implies that all PAHs released from matrixes into air could be recovered from the headspace using the SPME device of the present invention under these conditions.

### Example 5

Extraction of aroma ingredients from water was evaluated using the SPME device of the present invention. The aroma ingredients used in this experiment were organic compounds with a wide range of volatility and polarity. Extraction of these compounds from the headspace of aqueous matrixes was challenging, because most of these compounds are moderately polar, even polar compounds. Moreover, their concentrations in the headspace was very low due to their small Henry constants. Heating the matrixes would increase the concentrations of these compounds in the headspace and extraction of the heated samples using the internally cooled fiber would further increase the extraction efficiency.

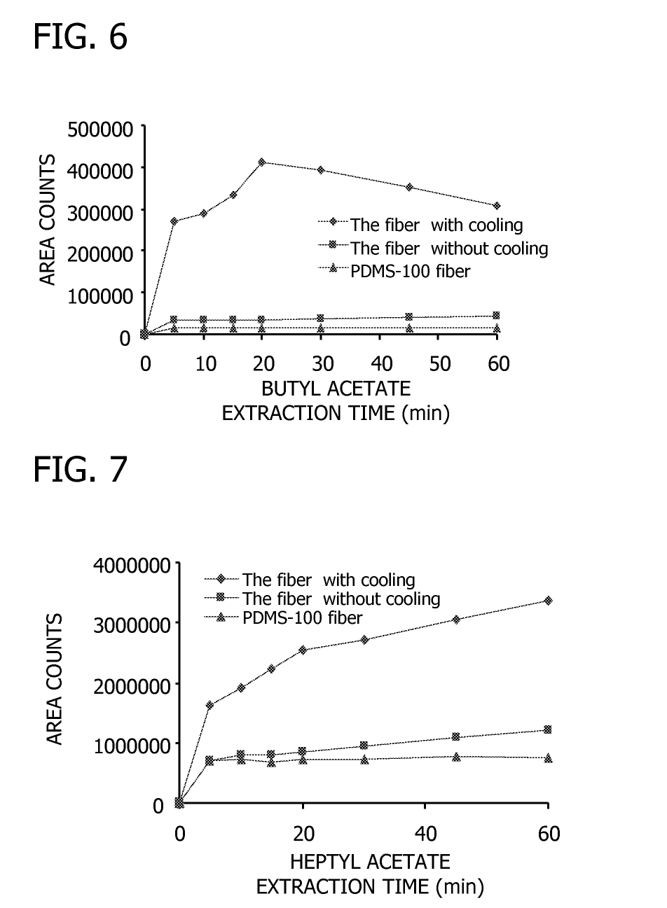

FIGS. 6 and 7 show the extraction time profiles of butyl acetate and heptyl acetate, representing low and high boiling point compounds in an aroma mixture. The SPME device of the present invention was used in two ways: with cooling the fiber to 1° C. and without cooling the fiber. Both results were compared with the extraction time profiles obtained with a commercialized 100 μm PDMS fiber. The extraction time profiles of the SPME device of the present invention, when it was not cooled, were similar to those of the commercialized 100 μm PDMS fiber. When the internally cooled fiber was cooled to about 1° C., the amounts of analytes extracted in the fiber were significantly increased. Table 2 summarizes the increase of extraction efficiency for each component of the aroma and the extraction reproducibility. Reasonable extraction reproducibility was observed for all the components (3 to 9%). It is noteworthy that heating the sample and simultaneously cooling the fiber affected the extraction efficiency of different compounds to different degrees. The increase in extraction efficiency varied from about twice for hexyl acetate and heptyl acetate to about 11 times for butyl acetate and (E)-2-hexenal. Three main reasons explain these differences. Firstly, the extraction equilibrium for some compounds was not reached under the experimental conditions; secondly, the heat capacities for different compounds are different; thirdly, the change of Henry constants with temperature was different for different compounds.

TABLE 2
Comparison of the extraction efficiencies of the SPME
device of the present invention with and without cooling.

| | Increase of | RSD of | RSD of |
|---|---|---|---|
| | the | extraction^{a} | extraction^{a} |
| | extraction | (%, n = 7, | (%, n = 7, |
| | efficiency | fiber with | fiber without |
| | (times) | cooling) | cooling) |
| Hexanal | 9 | 9 | 5 |
| Butyl acetate | 11 | 9 | 5 |
| (E)-2-Hexenal | 11 | 7 | 5 |
| Isoamyl | 5 | 5 | 5 |
| acetate | | | |
| Isobutyl | 6 | 7 | 5 |
| isobutyrate | | | |
| Hexyl acetate | 2 | 4 | 2 |
| Heptyl | 2 | 4 | 3 |
| acetate | | | |

^{a}Relative standard deviation (%) of the amounts of analytes extracted in the fiber

FIGS. 6 and 7 also demonstrate that the extraction equilibrium was reached in about 15 min for butyl acetate, but it was not reached even after 1 hour for heptyl acetate. Volatile compounds tend to partition into the headspace, leading to higher concentrations in the gaseous phase. As their distribution constants are small, only small amounts of analytes are required to be transferred to the fiber to establish the extraction equilibrium, which can be reached quickly. On the contrary, the concentrations of less volatile compounds in the headspace are low, and their distribution coefficients are large. Larger amounts of compounds need to be transferred from the aqueous solution to its headspace then to the coating, in order to reach extraction equilibrium, which requires a longer time. Increase of temperature and/or agitation would accelerate mass transfer, and thus shorten the equilibration time.

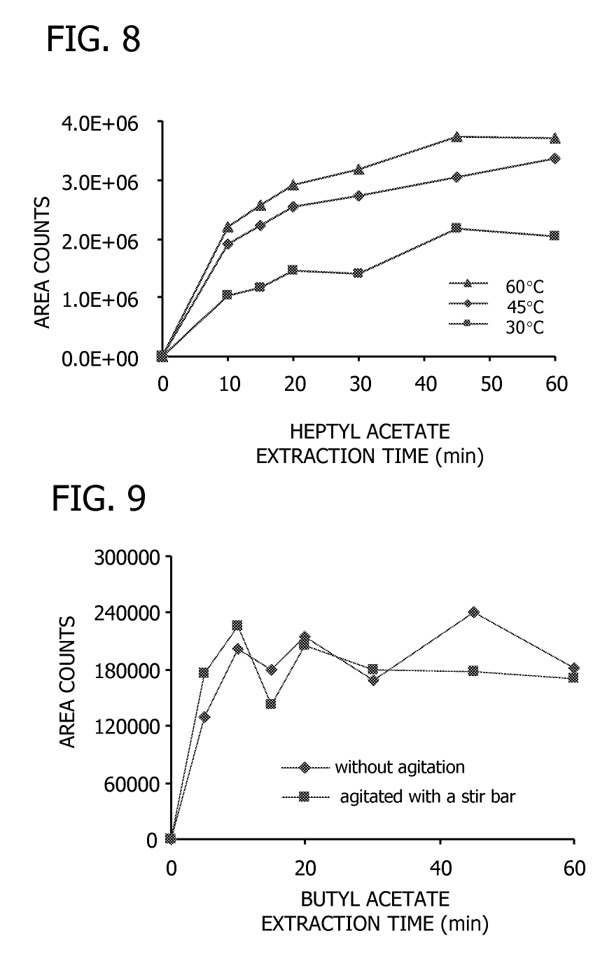

This is illustrated by the behavior of heptyl acetate. In a typical experiment, when the internally cooled fiber was cooled to about 1° C. during extraction, and the temperature of the sample was increased from 30 to 45, and then to 60° C., the amount of heptyl acetate extracted in the internally cooled fiber increased (FIG. 8). This could be ascribed to two reasons. Firstly, the temperature increase accelerated the mass transfer rate, which could increase the extraction efficiency for pre-equilibrium extraction. The second reason is that the increase of temperature gap between the internally cooled fiber and the sample increased the distribution coefficient, and subsequently the amount of analyte extracted in the internally cooled fiber.

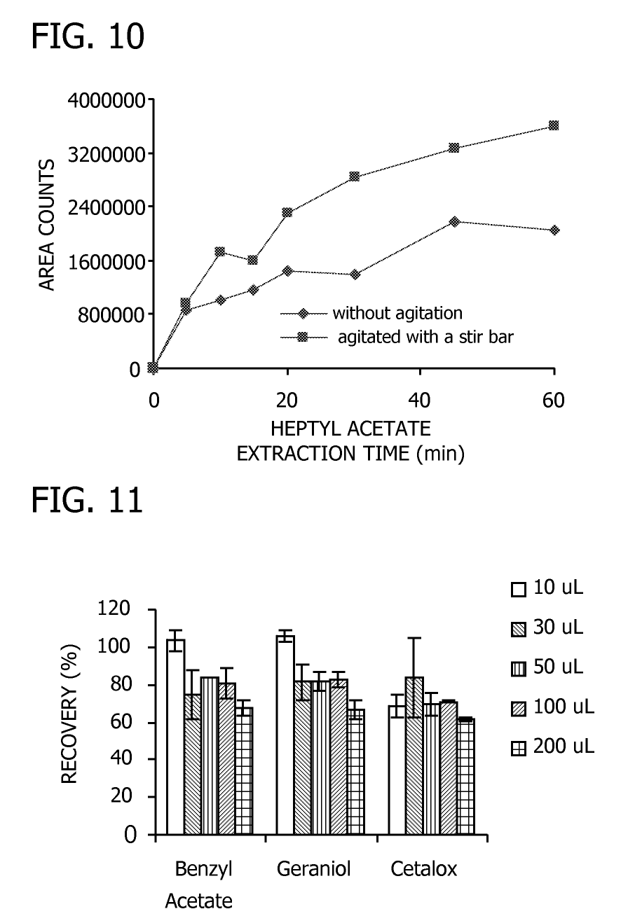

Due to the limited thermal stability of fragrance and flavor analytes in the matrixes, the maximum temperature investigated was 60° C. As a consequence, agitation was used to improve the extraction. Thus a micro magnetic stirrer was installed under the agitator, and a magnetic stir bar was put in samples prior to sealing the vials. The extraction of butyl acetate, which was mostly conducted from the headspace, was not affected by the agitation (FIGS. 9 and 10). In contrast, the agitation significantly affected the extraction of less volatile compounds such as heptyl acetate, because it accelerated their matrix-to-air mass transfer of less volatile compounds. Agitation is efficient only for less volatile compounds in liquid matrixes with small viscosity when the sampling temperatures are low. With elevated sampling temperatures, the mass transfer rate is increased by fast diffusion and convection induced by simultaneous heating samples and cooling the internally cooled fiber. When possible, increasing the sampling temperatures could be more efficient than agitation, for instance for matrices such as soils and oils.

To further explore the advantages of the SPME devices of the present invention, calibration curves were constructed and compared with those obtained by the use of a commercialized 100 μm PDMS fiber. All standards were agitated with a magnetic stir bar during extraction. The slopes of the calibration curves using the SPME device of the present invention were much higher than those of commercialized fiber, which implied that SPME device of the present invention was more sensitive to the concentration variation. Both fibers maintained wide linear ranges of at least 2 orders of magnitude. The limits of quantification (LOQ) using the internally cooled fiber were much lower, from 2 times to 10 times, than those using the commercialized fiber. However, the extraction with the commercialized fiber was more reproducible than that with the internally cooled fiber. This might be due to the larger temperature variation of the internally cooled fiber (±5° C.) compared to that of the commercialized fiber (less than ±0.5° C.).

Example 6 evaluated the extraction of perfume ingredients from shampoo. Traditional SPME under equilibrium extraction implies that only a small portion of analytes is extracted in the fiber coating. The disadvantage is that the change of matrix composition influences the free concentrations of analytes, and subsequently changes the amounts of analytes extracted in the fiber. Using the SPME device of the present invention under optimized conditions to achieve exhaustive extraction could overcome the drawbacks due to the matrix effects.

Eq. 6 describes the extraction of analytes from a sample with headspace using SPME under equilibrium,

$${n}_{f} = \frac{{K}_{fs} {V}_{f}}{{K}_{fs} {V}_{f} + {K}_{hs} {V}_{h} + {V}_{s}} {n}_{0} \qquad Eq . 6$$

To maximize the analyte recovery (n_{f}/n₀), K_{fs}, or V_{f} should be increased, or Kₕₛ, Vₕ, or Vₛ should be decreased. The most convenient way is to decrease the sample volume Vₛ and the volume of the headspace Vₕ. Utilizing a small size vial and a small amount of sample would significantly increase the recovery of analytes in the fiber.

FIG. 11 shows the effects of sample volume on the recovery of perfume ingredients. The extraction of aroma ingredients from water (9.3 μg/mL) was performed in the headspace of 8 mL of aqueous solutions in 20 mL vials. The samples were incubated at 30, 45, and 60° C., with and without agitation, for different times as indicated in the discussion. The extraction of perfume ingredients from shampoo was performed in 20 mL and 2 mL vials containing 10 to 200 μL of 1% shampoo aqueous solutions. The samples were incubated at 60° C. The extraction time was 45 minutes. When the volume of the sample was as low as 10 μL, benzyl acetate and geraniol were completely recovered. When the fiber was cooled with CO₂, the coating temperature was about 1±5° C. for all extractions. Full recovery of Cetalox® was not achieved for all cases, because the extraction was kinetically controlled, and a longer extraction time would be required.

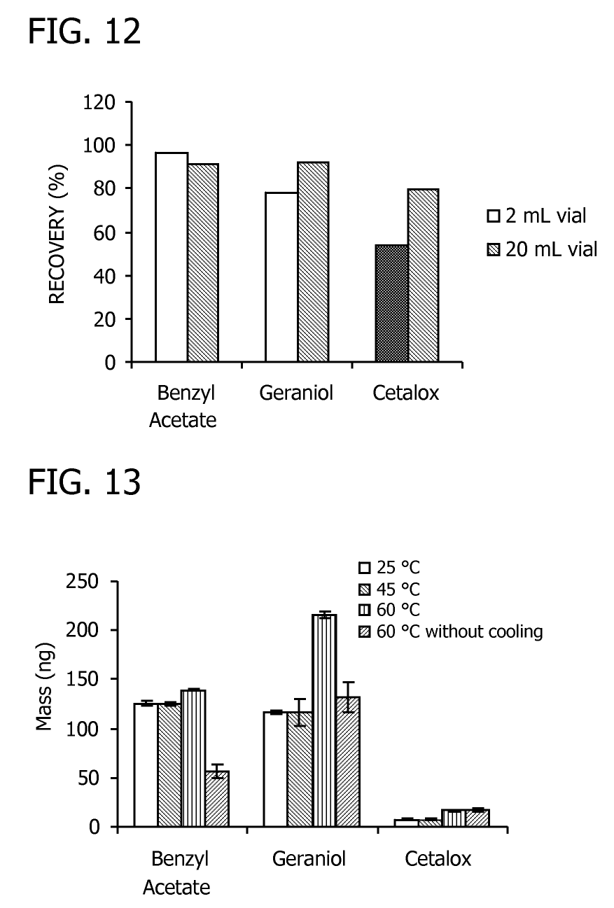

According to equation 6, the decrease of the vial volume would increase the recovery. However, equation 6 only describes equilibrium extraction. In practice, when decreasing the vial volume from 20 to 2 mL, the recoveries of benzyl acetate was improved as it reached equilibrium during the extraction. Conversely, the recoveries of geraniol and Cetalox®, for which equilibrium was not reached during the extraction time, were significantly decreased (FIG. 12). As the mass transport in the sample matrix and through the interface to its headspace was the rate-limiting process, the same amount of sample would possess higher surface-to-volume ratio in 20 mL vials than in 2 mL vials, which facilitated higher mass transfer rate.

Varying the sample temperature from 25 to 60° C. (FIG. 13) increased the extraction efficiency for all perfume compounds to different degrees. For benzyl acetate, the augmentation was not significant, because the recovery was also high (about 88%) at room temperature (˜25° C.). For geraniol and Cetalox®, the increase was more significant due to the accelerated mass transfer rates and the increase of distribution coefficient. The fiber coating was ‘zero sink’ to Cetalox®, meaning that the concentration of this compound at the fiber coating-headspace interface can be considered as zero, so the extraction efficiency was maintained even when the fiber coating was not cooled.

Table 3 summarizes the calibration details for the extraction of perfume ingredients from 1% shampoo aqueous solution using the internally cooled fiber. The method maintained large linear ranges in terms of concentrations of perfume ingredients in shampoo. Although the volume of the samples was significantly smaller, the sensitivity of the method was not jeopardized due to the higher recoveries and higher concentrations of perfume ingredients in standards with dilution of shampoo to only 1%.

TABLE 3
Calibration for the extraction of perfume compounds
from 1% shampoo aqueous solutions using the internally
cooled fiber

| | Y(mass, ng) = aX(concentration, | | | |
|---|---|---|---|---|
| | μg/g) + b | | | |
| | | b | | Linear range |
| | a (mass/(μg/g)) | (mass) | R² | (μg/g)* |
| Benzyl | 0.4497 | −9.0077 | 0.9937 | 6–2000 |
| acetate | | | | |
| Geraniol | 0.4606 | −8.3185 | 0.9989 | 8–3000 |
| Cetalox ® | 0.4288 | −1.0011 | 0.9952 | 1–300 |

| | | Reproducibility | |
|---|---|---|---|
| | Limit of Detection | of extraction (%, | |
| | (μg/g)* | n = 7) | Recovery (%) |
| Benzyl | 0.6 | 8 | 87 |
| acetate | | | |
| Geraniol | 1 | 9 | 90 |
| Cetalox ® | 0.2 | 9 | 83 |

*Concentrations were expressed as the concentrations of perfume ingredients in shampoo

It was also found that the calibration curves constructed with different types of shampoo did not differ significantly due to the high recoveries when the internally cooled fiber was used, which means that calibration curve constructed with one type of shampoo could be used to quantify perfume ingredients in other types of shampoo.

### Example 7

Example 7 evaluated the SPME device of the present invention for quantitative headspace extraction of PAHs in sediment.

Naphthalene, acenaphthylene, acenaphthene, fluorene, anthracene, fluoranthene and pyrene were purchased from Supelco (Bellefonte, Pa., USA). HPLC grade methanol and reagent grade sodium sulfate were purchased from EMD Biosciences (Affiliate of Merck KGaA, Darmstadt, Germany). Ultrapure water was collected from a Barnstead/Thermolyne NANOpure water system (Dubuque, Iowa, USA).

The stock standard solutions of naphthalene, acenaphthylene, acenaphthene, fluorene, anthracene, fluoranthene and pyrene (1000 mg/L) were prepared in methanol. The working standard solutions of PAHs were prepared by mixing the standard stock solutions, followed by appropriate dilutions with methanol. All PAH stocks and working standard solutions were stored at 4° C.

The sand matrix was provided by the Waterloo Center for Groundwater Research. All gases were supplied by Praxair (Kitchener, ON, Canada). Certified reference sediments of EC-2 (Lake Ontario blended sediment) and EC-6 (Lake Erie blended sediment) were purchased from the National Water Research Institute (NWRI) of Canada (Burlington, ON). Stainless steel tubing with different I.D. and O.D. were purchased from Vita Needle (Needham, Mass., USA). Temperature controller (CNi3244-C24 series), thermocouple wires, and high temperature cement were obtained from Omega (Stamford, Conn., USA). Hamilton gas-tight syringe (1710 series, 100 μL), and ferrules were obtained from Supelco. Solenoid valves were purchased from Asco Valve (Brandford, ON, Canada). Ten and twenty mL sample vials were used for the automated analysis with magnetic crimp caps and PTFE coated silicone septa (Supelco). Poly(dimethylsiloxane) liquid polymer tubing, with a thickness of 178 μm, was provided by NewAge Industries (Southampton, Pa., USA) and used as the PDMS fiber coating.

Gas chromatography was performed on a Varian 3800 GC coupled with a flame ionization detector (FID) using Star Chromatography Workstation (version 5.51). Method automation was realized using a CTC CombiPAL autosampler (Zwingen, Switzerland) with the associated Cycle Composer software (version 1.4.0). The CTC CombiPAL autosampler was equipped with a SPME syringe holder, a temperature controlled six-vial agitator tray and sample trays. Separations were performed using a 30 m×0.25 mm I.D., 0.25 μm CP-Sil & CB LOW BLEED/MS fused silica column from Varian (Mississauga, ON, Canada).

In order to analyze naphthalene, acenaphthylene, acenaphthene, fluorene, anthracene, fluoranthene and pyrene, helium was chosen as the carrier gas and set at a flow rate of 1 ml/min. The GC was operated in a splitless mode with a 2 min splitless period. The injector was maintained at 300° C. during the analysis. The column temperature was initially set at 50° C. for 1 min, increased to 150° C. at a rate of 15° C./min and held at 1 min, and finally ramped at 10° C./min to 280° C. and held constant until the end of the 35 min total run time. The FID was used at a temperature of 300° C. with gas flows for hydrogen, high purity air and nitrogen (make-up gas) set at 30, 300 and 30 ml/min, respectively.

The SPME device of the present invention was fabricated. The needle and plunger of a 100 μL Hamilton 1710RN gas-tight syringe (Supelco) were discarded and used as the barrel of the SPME device. The plunger was made from 22XX-gauge stainless steel tubing (O.D. 0.71 mm, I.D. 0.6 mm) with a length of 165 mm. One end of the tubing was welded to a half-round open cap using silver meld in the Machine Shop of the University of Waterloo, to provide the mechanical motion of the plunger inside the barrel and needle with the autosampler injection arm. The half-round shape and large inner volume of the cap also provided sufficient space to bend the CO₂ tubing with the axial motion of the autosampler injection arm, while not squeezing the tubing. The other end of plunger was sealed with a high-temperature cement after mounting the thermocouple wires. A K-type thermocouple was made from Alumel and Chromel wires (Omega). About 1 cm of isolation coating of the wires was removed and welded using a Spot Welding device (66 volts, limited current) equipped with a graphite anode, at the bare ends in the Electronic Shop at the University of Waterloo. Removing the wire coatings at the cooling region (1 cm which is equal to length of the fiber coating) provided enough space for the liquid CO₂ to exit from the tip of the CO₂ tubing, heat transfer for cooling and temperature measurement by the thermocouple. The other ends of the wires were connected to the temperature controller with a plug (Alumel, + and Chromel, −). The thermocouple was pulled through the plunger tubing from the head of the half-round open cap to the end used to support the fiber coating, so that the welded end was placed about 2 mm away from the opening. The end of the plunger was then sealed with high-temperature cement. The probe of the thermocouple, which was inside the plunger tubing, was located about 2 mm away from the opening. Sufficient cement was used to ensure the prevention of the leak in the plunger tubing and the fixing of the thermocouple's probe so that the movement of the device would not change the position of the probe. For complete hardening of the cement, at least 18 hours at room temperature was provided prior to use. After the high-temperature cement had hardened, the plunger was inserted through the empty barrel. A machined TEFLON ferrule and a piece of GC septum were then placed into the plunger.

33RW-gauge stainless steel tubing (O.D. 0.01 mm and I.D. 0.02 mm) was applied to deliver CO₂ for cooling the fiber coating to 0±3° C., while the temperature of the sample was 200° C. (the highest temperature limit of the agitator tray). It should be noted that the tip of CO₂ tubing, which is responsible for the cooling step in the process, should be designed as a restrictor. The liquid CO₂, which comes out of the capillary tubing, quickly evaporates and turns into CO₂ gas. During the evaporation of liquid CO₂, thermal energy is absorbed from the surrounding environment and consequently the fiber coating, attached on the surface of the plunger, can be effectively cooled while the sample is heated. Therefore, the tip of the CO₂ tubing acts as a restrictor, completely open to the CO₂ source and squeezed at the other end that is mounted into the plunger (the tubing is squeezed about 3 mm from the opening of the CO₂ tubing for optimal restriction). Otherwise, the restricting effect will occur over a longer length of the CO₂ tubing, which can be seen moisture droplets that then freeze along the tube as it exits the plunger. However, the used plunger (22XX-gauge) was compatible even with the 30RW-gauge stainless steel tubing (O.D. 0.3 mm and I.D. 0.15 mm) for further cooling of the fiber coating and/or using higher temperatures in the samples.

A 4.5 cm length of 18XX-gauge stainless steel tubing with a beveled end (which helps to pierce through septum of the GC injector and SPME vials) was used as the needle. A 0.4 mm graphite ferrule, which was modified by enlarging the center hole to accommodate the needle, was fixed on the other end of the needle. The combination of the graphite ferrule and a suitable rubber O-ring, which fitted into the nut and fixed around the graphite ferrule, provided a tight connection of the needle to the syringe barrel by screwing the needle nut. Tightening the needle nut pushed the graphite ferrule against the septum cut and the TEFLON ferrule, and ensured leak-free extractions and injections. Among the several types of ferrules that were evaluated, the septum cut ferrules most efficiently prevented leaks, even at high temperatures and pressure extractions. A 2.5 cm piece of 19XX-gauge stainless steel tubing (O.D. 1.1 mm, I.D. 0.95 mm) was placed on the plunger about 1.5 cm away from the end, as an adjustment tube. It was tightly fixed to the plunger by slightly squeezing on the plunger tubing. The O.D. of the adjustment tube was just a little larger than of the fiber coating so that it would be protected when pulled inside the needle. Without using the adjustment tube, the fiber coating was often stripped. Finally, a 1 cm piece of PDMS tubing, with a wall thickness of 178 μm (providing about 2.4 μl of extraction phase), was soaked in hexane. After the PDMS fiber sufficiently enlarged, it was placed on the tip of the plunger. As the hexane vaporized, the coating returned to its initial physical shape and tightly attached to the plunger tubing.

The final step in the process was to perform a leak-check of the fabricated syringe. For this purpose, the needle was inserted into a 20 ml SPME vial (with silicone/PTFE septa) containing 1 ml of methanol/water mixture (20/80, v/v) and the vial was heated to 100° C. for 10 min, and the syringe nut, the top hole of the barrel and the entrance of the plunger inside the half-round open cap were checked for leaks. The fiber coating was then conditioned for 1 hr at 300° C. As tested, it was determined that the SPME device of the present invention can be used for more than 100 injections.

The SPME device of the present invention was fully automated. The needle guide of the CTC CombiPAL autosampler was drilled and enlarged to accommodate the needle. The SPME device of the present invention was put on a 100 μl syringe holder and fixed on the autosampler arm. Then, the option of “fiber” was selected in the control panel of autosampler display. The holes of the septum nut and septum support of the GC instrument were also enlarged for the needle, and a 2 mm liner was used. The septum was pre-drilled, to avoid coring and to prolong its lifetime. Pre-drilled septa can be used for at least 10 leak-free injections. Using the septum without the pre-drilling may push some separated pieces of septum into the liner and causes a memory effect due to adsorption.

The needle of the proposed device was not flexible enough to allow for agitation of samples by rotating the agitator tray during the extraction. In addition, at high temperatures, the temperature gap between the fiber coating and the sample matrix facilitated diffusion and convection of the analytes inside the sample matrix and headspace. However, using a pre-agitation step prior to the extraction compensates for the lack of agitation during the extraction phase.

A solenoid valve and a temperature controller electronically coupled with the CTC CombiPAL autosampler were used to control the CO₂ flow and precisely control the temperature of the fiber coating. The thermocouple was used to monitor the temperature of the fiber coating, and was connected to the temperature controller, which could turn the solenoid valve on or off as required. This combination allowed for temperature control of the fiber coating within ±3 degrees at preset value. The external temperature controller was equipped with a logic circuit and the Electronic Shop of the University of Waterloo provided suitable software (VB DAS using iSeries ActiveX). This system could send the temperature data to the computer, and the temperature of the fiber coating was then recorded at a preset time interval (at least 1 sec) during the each analytical run. The schematic of the full automatic SPME device of the present invention is shown in FIG. 3.

Because of the difficulty related to the extraction of semi-volatile compounds from solid matrices, the focus of this work was on sand and sediment samples. These matrices were used to optimize the experimental conditions of the SPME device of the present invention. In a next step, PAHs were extracted from solid samples. Seven PAHs (naphthalene, acenaphthylene, acenaphthene, fluorene, anthracene, fluoranthene and pyrene) from the EPA (Environmental Protection Agency) list were chosen for the trials. The sand samples were prepared by spiking different amounts of PAHs standard solution in 2 g of sand in 20 ml vials, and the samples were subsequently agitated for 1 hr at room temperature. Preliminary studies showed that the extracted amounts of PAHs from the spiked sand samples reduced gradually within 24 hrs of the spiking time and then remained constant, suggesting that the sand and PAH mixture equilibrated after at least 24 hrs. Thus, the spiked sand samples were left for 24 hrs prior to extraction, to allow for equilibration and stabilization of the PAHs in the matrix.

A 15 min pre-agitation step was performed at 150° C. to ensure a complete equilibrium between the headspace and sand matrix upon extraction. The PAHs were then extracted in the headspace at 150° C. for 40 min while the fiber coating temperature was maintained at 5° C. The extracted amounts of PAHs were evaluated by injecting the fiber coating of the GC instrument and applying the peak area values to the suitable direct injection calibration curves.

The quantitative extraction of PAHs from the certified reference sediments was done in the headspace of 20 ml vials containing 50 mg of EC-2 and 100 mg of EC-6 reference sediments with the proposed CF-HS-SPME device using the standard addition method, under optimum experimental conditions (pre-agitation time: 15 min, pre-agitation temperature: 150° C., temperature of the fiber coating: 5° C., extraction temperature: 150° C., extraction time: 40 min, extraction time for fluoranthene and pyrene: 180 min).

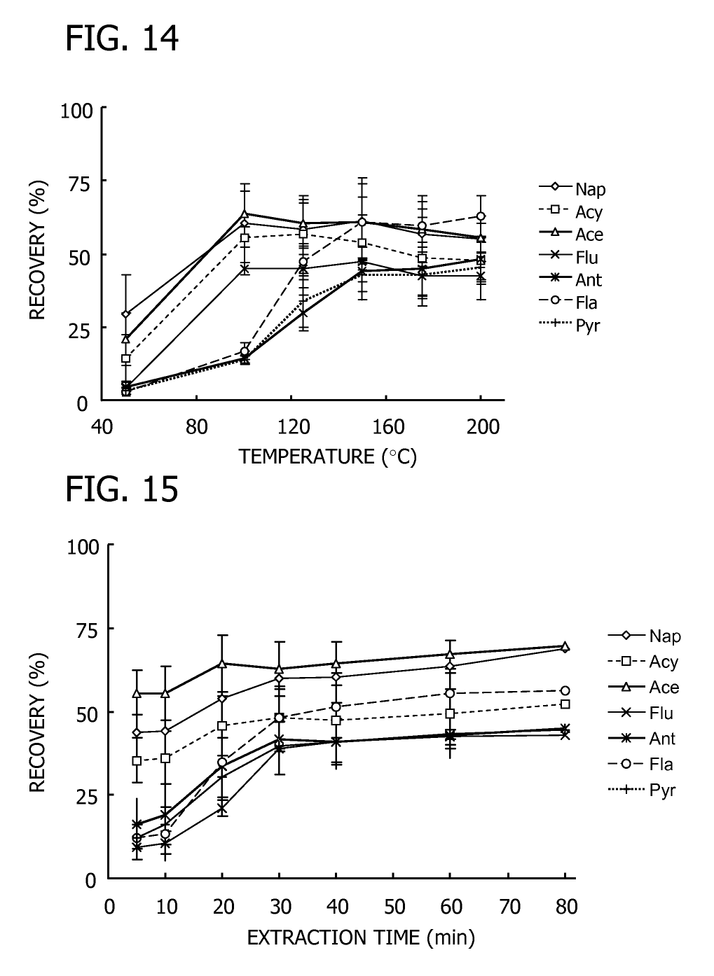

Extraction-temperature profiles for the sand samples were studied by monitoring the extracted amounts of PAHs as a function of the extraction temperature using the SPME device of the present invention. As the results show in FIG. 14, an increase in the extracted amounts corresponded with an increase in the temperature of the sample matrix to 150° C. for naphthalene (Nap), acenaphthylene (Acy), acenaphthene (Ace), fluorene (Flu) and to 200° C. for anthracene (Ant), fluoranthene (Fla) and pyrene (Pyr). However the increasing rates of the extracted amounts for the compounds with higher boiling points (anthracene, fluoranthene and pyrene) were more significant at temperatures higher than 100° C., while between 150 and 200° C., they were low. On the other hand, the compounds with lower boiling points (naphthalene, acenaphthylene, and acenaphthene) exhibited a small decrease in the extraction efficiency after 150° C. was reached due to (a) a higher temperature gap between the coating's surface and its internal section (temperature monitoring site) at high headspace temperatures and (b) additional cooling of the coating at the section near the tip of the CO₂ tube while the other components remained warm. This resulted in a decrease in the affinity for adsorption, especially for lower boiling point PAHs. Therefore, 150° C. was selected as the optimum temperature for extraction of PAHs from sand.

In order to, study the effect of exposure time on the extraction of PAHs, the sand samples were extracted at 5, 10, 20, 30, 40, 60, and 80 minutes. As shown in FIG. 15, the extracted amounts increased with increasing extraction time, at a constant temperature, and reached a plateau when equilibrium was established. Thus, 40 min was chosen as optimum extraction time, providing sufficient extracted amounts within a reasonable assay time.

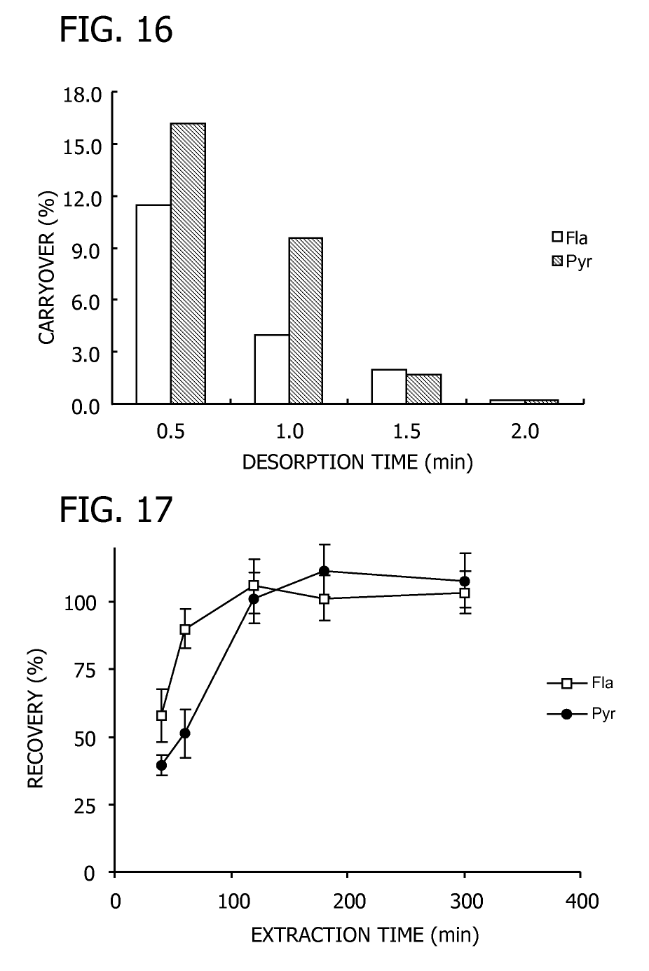

The sand sample with a silica-based matrix, containing different metal oxides, is a good adsorbent of PAHs molecules. In order to achieve an equilibrium between the headspace and the sand matrix spiked with PAHs, prior to the extraction using the SPME device of the present invention, different agitation times were tested at 150° C. The results suggest that at least 15 min of pre-agitation is required for the provision of adequate mass transfer for the PAHs and constant extraction efficiency. Thus, a 15 min pre-agitation time was used for all additional experiments. Because of larger thickness of the used fiber coating (178 um), compared with commercial ones, it was decided to examine desorption time and carry-over effect. FIG. 16 shows the dependence of carry-over of Fluoranthene (Fla) and Pyrene (Pyr), with the highest boiling points on the desorption times. From the results, it is clear that the desorption of the PAHs are complete after 2 min at 300° C. Hence, 2 minutes was used as the optimal desorption time for all of the experiments.

Calibration curves were obtained using sand samples that were spiked with a series of standard solutions. All 7 calibration curves exhibited good linearity, with regression coefficients ranging from 0.9908 to 0.9997. Limits of detection (LODs) and limits of quantitation (LOQs) are provided in Table 4. The lowest LOD was 0.3 pg/g for acynaphtylene, while fluoranthene and pyrene exhibited the highest LOD, at 3 pg/g. The very low LODs obtained are remarkable compared to those generally reported in the art. The relative standard deviations (RSDs) of the proposed SPME device method for the sand samples with different concentrations of PAHs are given in Table 5. For the sand samples containing 1 ng/g of each PAH, the RSDs were in the range of 7.5 to 21.5%, which is reasonable, considering the very low concentration of PAHs in the solid matrices and no further pre-treatment of the samples.

TABLE 4
Limit of detection, limit of quantitation, dynamic
linear range, regression coefficient and regression
equation for 7 PAHs in the sand samples analyzed by CF-
HS-SPME method.

| | LOD | | DLR | | |
|---|---|---|---|---|---|
| Compound | (pg/g) | LOQ (pg/g) | (ng/g) | R² | Regression equation |
| Naphthalene | 0.5 | 1.5 | 0.0015–1000 | 0.9966 | y = 4642.9x + 38313 |
| Acenaphthylene | 0.3 | 0.9 | 0.0009–1000 | 0.9962 | y = 7642.3x + 64843 |
| Acenaphthene | 0.4 | 1.2 | 0.0012–1000 | 0.9942 | y = 10091x − 100910 |
| Fluorene | 0.5 | 1.5 | 0.0015–1000 | 0.9997 | y = 8760.6x − 18722 |
| Anthracene | 2.5 | 7.5 | 0.0075–1000 | 0.9936 | y = 6278.6x − 28276 |
| Fluoranthene | 3 | 9 | 0.009–1000 | 0.9908 | y = 8213.2x + 140803 |
| Pyrene | 3 | 9 | 0.009–1000 | 0.9976 | y = 8690.8x + 30155 |

TABLE 5
Relative standard deviation for recovery of 7 PAHs
from four sand samples with different concentrations
using CF-HS-SPME (n = 3)

Concentration (ng/g)

| Compound | 0.005 | 1 | 500 | 1000 |
|---|---|---|---|---|
| Naphthalene | 22.0 | 7.5 | 6.0 | 7.3 |
| Acenaphthylene | 31.8 | 18.4 | 15.7 | 3.9 |
| Acenaphthene | 13.4 | 10.6 | 4.5 | 1.2 |
| Fluorene | 14.2 | 7.3 | 7.2 | 6.0 |
| Anthracene | 11.3 | 16.9 | 13.7 | 6.3 |
| Fluoranthene | 23.4 | 21.3 | 16.0 | 7.8 |
| Pyrene | 47.3 | 20.5 | 11.6 | 8.9 |

There are many types of soils and sediments in the world, and their adsorption characteristics are related to the composition of the matrices. The final phase of Example 7 was an evaluation of the proposed method with contaminated sediment samples. Two sediment samples were analyzed, including EC-6, with a relatively low concentration of PAHs, chlorobenzenes and PCBs (from Lake Erie), and EC-2, with a relatively high concentration of the same pollutants (from Lake Ontario). Those samples represent extreme examples of sediment types that could be encountered during environmental investigations.

Different amounts of EC-6 and EC-2 reference sediments were analyzed using the SPME device method of the present invention under optimal experimental conditions. It was revealed that by using more than 100 mg of EC-6 and 50 mg of EC-2, a hump shape baseline was evident in the chromatogram (from 15 to 25 min), due to high levels of organic compounds. It was concluded that naphthalene, acenaphthylene, acenaphthene, fluorine and anthracene could be quantitatively extracted, but the extraction efficiency of fluoranthene and pyrene was lower than 40%. To improve the extraction efficiency of fluoranthene and pyrene, the samples were spiked with 10, 20 and 50 μl of methanol as an organic modifier, but this produced negligible differences in the percent recoveries. Neither sonication of the sediment samples for 1 hr at room temperature nor mixing the samples with 1 g of sodium sulfate improved the extraction efficiency. However, spiking 50 mg of EC-6 and 100 mg of EC-2, with 10, 20 and 50 μl of water did increase the extraction percent of fluoranthene and pyrene by about 30%. On the other hand, spiking with higher amounts of water is not a reasonable solution, its evaporation at 150° C. causes a high pressure in the extraction vial and increases the risk of leaking, especially for lower boiling point compounds such as naphthalene. Thus, longer extraction times were examined for quantitative extraction of fluoranthene and pyrene, taking into account the high adsorptive nature of sediments for PAHs, compared to sand.

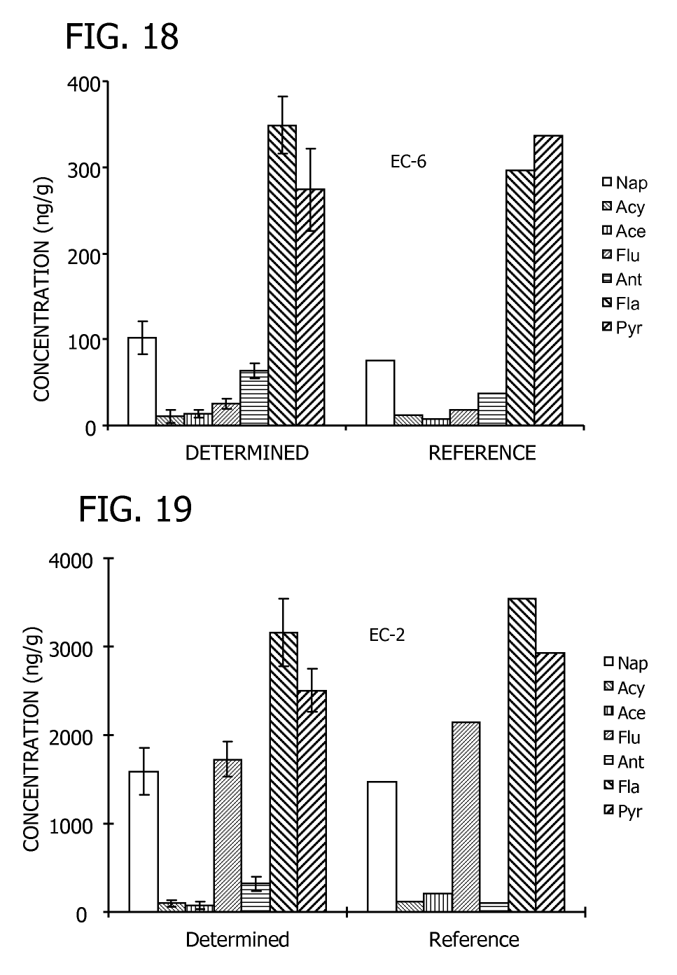

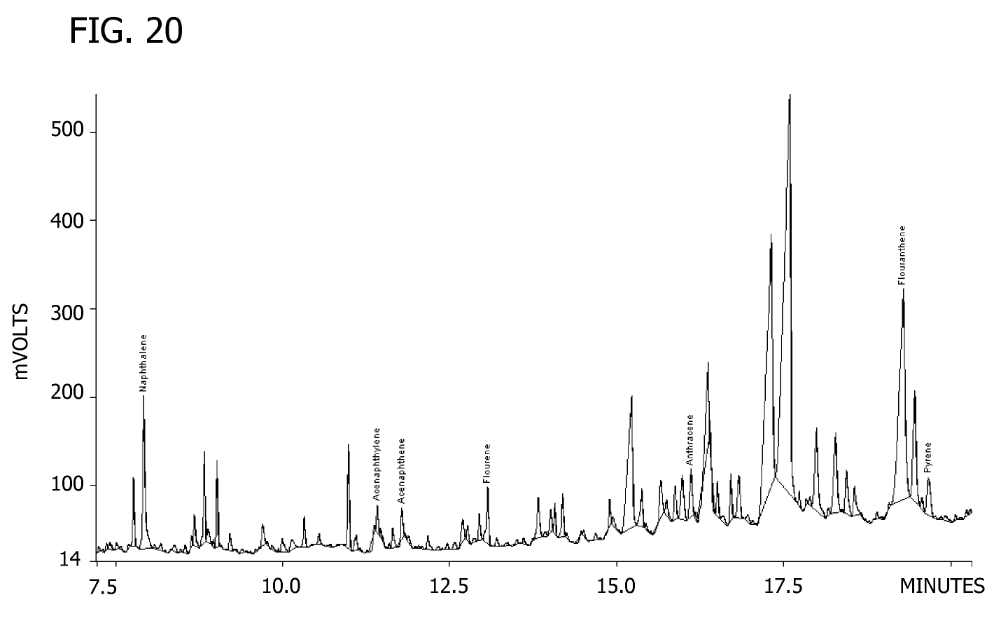

The extraction-time profiles (FIG. 17) illustrate that the exhaustive extraction of fluoranthene (Fla) and pyrene (Pyr) from sediment samples occurred after 120 and 180 min, respectively. Hence, the quantitative analysis of PAHs in EC-6 and EC-2 sediment samples were pursued using the standard addition method, under the following optimal experimental conditions: a pre-agitation time of 15 min; a pre-agitation temperature of 150° C.; a fiber coating temperature of 5° C.; an extraction temperature of 150° C.; and an extraction time of 180 min. As the results (FIG. 18 and FIG. 19) show, a satisfactory agreement exists between the values obtained by the SPME-GC device method of the present invention and those reported by the National Water Research Institute (NWRI) of Canada. FIG. 20 shows the chromatogram of the quantitative extraction of 50 mg of EC-6 sediment sample.

The automated SPME-GC device method of the present invention offers significant analytical performance, very good sensitivity and reasonable precision. It is a powerful method for the direct quantitative analysis of volatile organic analytes in complex environmental samples.

### Example 8

Example 8 describes the fabrication of the SPME device of the present invention having thermoelectric cooling as depicted in FIG. 2. The internally cooled SPME device was built at the University of Waterloo. The hot side of the thermoelectric cooler (TEC) was attached to a heat sink 5, which was in turn attached to a fan 10. The heat sink 5 and fan 10 combination were used to dissipate the heat generated on the hot side. A copper plate 15 was attached to the cold surface of the TEC. A groove of 0.5 mm depth was made in the middle of the copper plate 15, which acted as a seat for the SPME fiber. A K-type thermocouple (not shown) was embedded at the copper plate 15 close to the groove to monitor the temperature of the cold side of the TEC. Two pieces of aluminum (upper 20 and lower 25 pieces) were machined to serve as the seat for the SPME plunger 30 (upper piece), the septum and the needle hub 35. Three aluminum plates were also used as the sides of the device 40. A small plastic part was machined and mounted on the SPME plunger to hold a copper wire 45. In order to achieve better cooling, the empty space between the copper plate and the aluminum parts was filled with glass wool (not shown).

The custom made SPME fiber was made using a copper wire 45 of 0.762 mm diameter and 8.5 cm length. One centimeter of a polydimethyl siloxane (PDMS) hollow fiber 50 was cut, swollen in hexane, and placed at the tip of the copper wire to serve as the extraction phase. Stainless steel tubing of sufficient diameter to receive the coated fiber 50 was used for the needle 55.

A direct current (DC) power supply (not shown) and a custom-made voltage regulator (not shown) were used to supply the appropriate power both to the TEC and the fan 10. The total voltage required to run the system was 12 volts. The temperature of the cold side of the TEC was controlled by the direct current passing through TEC. The PDMS coating 50 was cooled through heat transfer along the copper wire 45, which is in contact with the cold surface of the TEC.

The device was applied in quantitative analysis of off-flavors in a rice sample with the method of standard addition.

Hexanal, nonanal, undecanal, nonane, and 2,4,6-Trimethylpyridine (TMP), were all purchased from Sigma-Aldrich (Mississauga, ON, Canada). Optima grade methylene chloride and HPLC grade methanol were purchased from EDM Biosciences (Affiliate of Merck, Darmstadt, Germany). All Gases were purchased from Praxair (Kitchener, ON, Canada).

Two and ten milliliter sample vials with crimp caps and PTFE coated silicone septa, as well as thermo green septum which was used in fabricating the cold fiber device were purchased from Supelco (Bellefonte, Pa., USA). Thermoelectric cooler and related heat sink and fan were purchased from Melcor (Trenton, N.J., USA). Hypodermic stainless steel tubing of gauge 18 (18XX, inner diameter: 1.143 mm, outer diameter: 1.27 mm) was purchased from Vita Needle (Needham, Mass., USA). Polydimethylsiloxane liquid polymer tubing, with a thickness of 178 μm was purchased from New Age Industries (Southampton, Pa., USA) and was used as the SPME fiber coating. K-type Thermocouples, copper wire (0.762 mm diameter used as the SPME support) and digital thermometer were purchased from Omega (Stamford, Conn., USA).

The brand of rice sample used in this study was Basmati Khushi, which was purchased from a local supermarket in Waterloo, ON, Canada. The samples were prepared by grinding rice grains, using a household coffee grinder. The rice sample was kept in the refrigerator and the ground samples were freshly prepared everyday before analysis.

Gas chromatography was performed on a Varian 3800 GC system coupled to a flame ionization detection (FID) system using Star Chromatography Workstation software (version 5.51). Separations were performed using a 30 m×0.25 mm I.D., 0.25 μm CP-Sil & CB Low Bleed/MS fused silica column from Varian (Mississauga, Canada). Helium was chosen as the carrier gas. The GC was operated in a splitless mode with a 2 min splitless period. The injector was maintained at 300° C. during the desorption splitless time. When performing SPME extractions, the column temperature was initially set at 40° C. for 1 min, increased to 150° C. at a rate of 7° C./min and held for 1 min, and finally ramped at 30° C./min to 280° C. and held constant until the end of the 30 min total run time. The FID system was used at a temperature of 300° C. with gas flows for hydrogen, high-purity air and nitrogen (make-up gas) set at 30, 300 and 30 ml/min, respectively. The carrier gas flow rate was set at 1 mL/min. For direct liquid injection: the injector temperature was ramped from 60 to 250° C. and the carrier gas flow rate was increased to 7.2 mL/min. All other parameters were kept the same. The injector nut and the septum support were drilled to be large enough to host the relatively large needle used in the cold fiber device. And a liner with inner diameter of 4 mm was suitable for this purpose.

Hexanal, nonanal, and undecanal were chosen as target off-flavors in rice. Their existence in the used rice sample was verified by comparing the retention times to those of the standards A 300 μg/mL solution of nonane was prepared and used as the internal standard. Standard solutions with increasing concentrations with respect to the target analytes were prepared and used in standard addition method for quantifying the target analytes in the rice samples.

In all experiments, 2 g of ground rice was loaded in 10-mL crimp cap vials. The samples were then spiked with 1 μL of the standard solution and were immediately capped. The vial was then transferred to the heater/agitator, which was previously set at the experimental temperature and the sample was shaken for 10 minutes. The fiber, which was already cooled, was then exposed to the headspace of the rice sample to perform extractions. After the desired extraction time, the fiber was removed from the vial and transferred to the GC injector and the TEC was turned off. The device was left at the injector during the GC run time to make sure there was no carry over.

The concentration of hexanal in the rice samples was measured using three 0.6 g ground rice samples were prepared in 2 ml crimp cap vials and 0.5 ml of stock solution was added to each vial. The stock solution consisted of methylene chloride with 0.0914 μl/mL of 2,4,6-trimethyl pyridine (TMP: collidine, Aldrich) used as internal standard. The extractions were performed at 85° C. in a water bath for 3.5 hours. After centrifugation the extraction liquid was pipetted off and 3 μl of each solution was injected into the GC/FID for analysis.

In order to obtain the extraction temperature profile, the analytical procedure explained in the experimental section was performed with an extraction time of 20 minutes. Extraction temperatures of 50, 70, 90, and 110° C. were investigated. Higher temperatures were avoided since there was the possibility of burning the rice samples. The same experiments were performed using a commercially available DVB/CAR/PDMS fiber and each experiment was repeated three times. DVB/CAR/PDMS is the commercially available fiber, which is recommended for aldehydes and has been used for the extraction of hexanal from the headspace of rice samples. As mentioned previously, increasing the temperature of the sample results in higher vapor pressures of the analytes in the headspace but it can only result in higher extracted amounts on SPME fiber, if the temperature of the fiber is low enough to have the same or higher partition coefficients between headspace and the fiber. The temperature profiles for commercial SPME represent the extraction temperature profiles when the fiber and the sample are both at the same temperature. The profiles showed a maximum temperature of 70° C. for hexanal and nonanal and 90° C. for undecanal. Increasing the temperature to higher temperatures resulted in lower extraction recoveries due to the decrease in the value of partition coefficients of the analytes on the fiber. The maximum point is increased from 70 to 90° C. for undecanal because it has a higher affinity for the fiber and a higher temperature is required to lower the partition coefficient of this compound between the fiber and the headspace of the sample.

When using cold fiber extraction from the headspace of the rice sample, the extraction temperature profiles showed that the recoveries of extraction for all analytes increased with increasing the temperature of the sample from 50 to 90° C. The reason is that the vapor pressure of all analytes was increased in the headspace and the temperature gap between the fiber and the sample resulted in trapping the more volatile compounds. When the temperature was increased from 90 to 110° C., the amount of hexanal extracted on the fiber did not change significantly, whereas, those of nonanal and undecanal were increased with a factor of 1.5. This was predictable, because nonanal and undecanal are less volatile compared to hexanal and higher temperatures are required to release them from the matrix to the headspace.

Extraction time profiles were obtained at three different sample temperatures (70, 90, and 110° C.). The incubation time was 10 minutes for all experiments and the extraction time was increased over the range of 5 to 60 minutes. Each experiment was performed 3 times. The extraction time profiles showed that increasing the temperature results in shorter equilibrium times at the fiber. Diffusion of the analytes through the gaseous phase (headspace) is temperature dependent and increasing the temperature results in faster mass transfer of analytes through the headspace and the temperature gap between the fiber and the headspace results in faster equilibrium on the fiber; therefore, cooling the fiber while heating the sample not only results in higher extraction recoveries, but also speeds up the kinetics of extraction. Extraction time of 30 minutes and 10 minutes were chosen as optimum extraction times, for extractions at 70° C. and 110° C. sample temperatures, respectively.

Hexanal, nonanal and undecanal were quantified in the chosen rice sample by headspace cold fiber headspace SPME using the method of standard addition. The concentration of hexanal was also determined using a conventional solvent extraction method in order to compare the cold fiber headspace SPME method with an exhaustive extraction method.

The concentrations of the three target analytes were calculated using the standard addition calibration graphs, obtained at 70 and 110° C. Table 6 shows the equations of the calibration graphs, the square of regression coefficient and the calculated concentrations for each compound. The calculated concentration of all compounds is higher at 110° C. This can be explained by higher vapor pressure of the analytes in the headspace at this temperature.

TABLE 1
Concentrations of hexanal, nonanal, and undecanal in
rice at (a) 110° C. and (b) 70° C.

| | Com- | | | Concentration |
|---|---|---|---|---|
| Temperature | pound | Equation | R² | (ng/g) |
| 110° C. | Hexanal | y = 399.03x + 513934 | 0.998 | 644 ± 8 |
| 110° C. | Nonanal | y = 1400.6x + 427919 | 0.991 | 153 ± 17 |
| 110° C. | Undecanal | y = 2014.8x + 37156 | 0.992 | 9 ± 1 |
| 70° C. | Hexanal | y = 733.66x + 294170 | 0.998 | 200 ± 4 |
| 70° C. | Nonanal | y = 2650.5x + 294554 | 0.999 | 56 ± 6 |
| 70° C. | Undecanal | y = 1110.8x + 9545.1 | 0.997 | 4 ± 1 |

The GC/FID was calibrated with respect to hexanal and the internal standard (TMP) using standard solutions of hexanal and TMP in hexane. The concentration of hexanal was then calculated by comparing the ratio of the peak area of hexanal to the peak area of internal standard (TMP) obtained from direct injection of the unknown solution (the extract) to those of the standard solutions. The concentration of hexanal was found 1035±15.

The new cold fiber SPME device with thermoelectric cooler is a simple, rapid, and sensitive extraction device for the quantitative analysis of volatile compounds in the headspace of food samples, e.g. rice. The recovery of extraction of off-flavors from rice was higher when using the cold fiber device in compare to commercial SPME fiber and was comparable to the conventional solvent extraction methods. The method can be applied in genetic and storage studies to assist rice breeders to select high quality rice samples. This low voltage device can be operated by a car battery and be used in field extractions e.g. in the extraction of fragrances from live flowers (results not discussed in this article). The technique can be further improved by the use of more efficient thermoelectric coolers which are recently available. It can also be easily automated and combined with mass spectroscopy instrument, which makes it a very suitable technique for screening the flavors in food samples.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above products and methods without departing from the scope of the invention, it is intended that all matter contained in the above description and shown in the accompanying drawings shall be interpreted as illustrative and not in a limiting sense.

What is claimed is:

1. A solid phase microextraction device comprising a sorbent, an internal cooling device and an internal thermocouple wherein:
the internal thermocouple measures sorbent temperature;
the internal cooling device is operatively connected to the sorbent; and
the internal cooling device comprises a tube for supplying a coolant.

2. The solid phase microextraction device of claim 1 further comprising:
a barrel having an internal passage therethrough and a needle having an internal passage therethrough,
the needle and barrel being cojoined and cooperatively defining a passage therethrough, the passage having a length,
wherein the sorbent is a fiber coating on a coating support, the coating support comprising a tube having ends and a length, the coating support being inserted into the passage, the length of the coating support being greater than the length of the passage so that each of the coating support ends are disposed outside of the passage, and
a seal disposed between the barrel and coating support.

3. The solid phase microextraction device of claim 2 wherein the needle is a tube having a maximum internal diameter of about 1.14 mm.

4. The solid phase microextraction device of claim 3 wherein the coating support tube is internally disposed in a protective sleeve comprising a tube having a maximum internal diameter of about 0.95 mm and a maximum external diameter of about 1.08 mm, the protective sleeve being internally disposed in the needle.

5. The solid phase microextraction device of claim 1 wherein the solid phase microextraction device is operatively connected to a gas chromatographic autosampler.

6. The solid phase microextraction device of claim 5 wherein the internal cooling device tube is operatively connected to a modulating valve for controlling coolant supply and a temperature controller,
wherein the thermocouple, internal cooling device, modulating valve, and temperature controller form a temperature control loop and the gas chromatographic autosampler activates and deactivates the control loop.

7. The solid phase microextraction device of claim 1 wherein the coolant is carbon dioxide.

8. A solid phase microextraction method comprising:
heating a sample to generate a vaporized analyte;
exposing the vaporized analyte to a solid phase microextraction device, the solid phase microextraction device comprising a sorbent, an internal thermocouple, and an internal cooling device comprising a tube for supplying a coolant, the internal cooling device being operatively connected to the sorbent;
cooling the sorbent to a temperature of from about −20° C. to about 25° C.;
absorbing the analyte into the sorbent; and
desorbing the analyte into an analytical instrument.

9. The method of claim 8 wherein the internal cooling device tube is operatively connected to a modulating valve for controlling coolant supply and a temperature controller,
wherein the thermocouple, internal cooling device, modulating valve, and temperature controller form a temperature control loop and the temperature is controlled.

10. The method of claim 8 wherein the analytical instrument is a gas chromatograph and the solid phase microextraction device is operatively connected to a gas chromatographic autosampler.

11. The method of claim 10 wherein the internal cooling device tube is operatively connected to a modulating valve for controlling coolant supply and a temperature controller,
wherein the thermocouple, internal cooling device, modulating valve, and temperature controller form a temperature control loop, the gas chromatographic autosampler activates and deactivates the control loop, and the temperature is controlled.

12. The method of claim 8 wherein the sorbent is a fiber coating on a tubular coating support, the internal thermocouple and internal cooling device being disposed in the coating support, the coating support having a maximum internal diameter of about 0.6 mm.

13. The method of claim 8 wherein the temperature difference between the heated sample and the sorbent is from about 25° C. to about 370° C.

14. The method of claim 8 wherein the sample is heated by convective heating, microwave heating, sonication or a combination thereof.

15. The method of claim 8 wherein the analyte comprises nanoparticles.

16. The method of claim 8 wherein the coolant is carbon dioxide.

17. A solid phase microextraction device comprising a sorbent, an internal cooling device and a needle wherein:
the needle is a tube having a passage therethrough;
the cooling device is a thermoelectric fiber;
the sorbent is a fiber coating on the thermoelectric fiber and the thermoelectric fiber is operatively connected to the sorbent; and
the fiber coating on the thermoelectric fiber is received into the passage.

18. The solid phase microextraction device of claim 17 further comprising a thermocouple operatively mounted in the tip of the thermoelectric fiber and a temperature controller, wherein the thermocouple, the thermoelectric fiber and the temperature controller form a temperature control loop and the temperature is controlled.

19. The solid phase microextraction device of claim 17 further comprising a power source connected to the thermoelectric fiber wherein:
the power source is a battery allowing for portability of the solid phase microextraction device.

20. A solid phase microextraction method comprising:
heating a sample to generate a vaporized analyte;
exposing the vaporized analyte to a solid phase microextraction device, the solid phase microextraction device comprising a thermoelectric cooling wire having an operationally connected sorbent disposed thereon;
cooling the sorbent to a temperature of from about −20° C. to about 25° C.;
absorbing the analyte into the sorbent; and
desorbing the analyte into an analytical instrument.

21. The method of claim 20 wherein the temperature difference between the heated sample and the sorbent is from about 25° C. to about 370° C.

22. The method of claim 20 wherein the analyte comprises nanoparticles.
